(19) United States
(12) Patent Application Publication
(10) Pub. No.: US 2025/0309990 A1
(43) Pub. Date: Oct. 2, 2025

(54) OPTICAL TRANSMITTER AND OPTICAL TRANSCEIVER

(71) Applicant: Fujitsu Limited, Kawasaki-shi (JP)

(72) Inventors: Hideyuki MATSUURA, Sendai (JP); Kosuke KOMAKI, Kawasaki (JP); yoshitaka NOMURA, Shinagawa (JP); Katsutoshi ISHIDOU, Tooda (JP)

(73) Assignee: Fujitsu Limited, Kawasaki-shi (JP)

(21) Appl. No.: 19/059,613

(22) Filed: Feb. 21, 2025

(30) Foreign Application Priority Data
Mar. 29, 2024 (JP) 2024-055775

(51) Int. Cl. H04B 10/40; H04B 10/079; H04B 10/69

(52) U.S. Cl. CPC H04B 10/40; H04B 10/07955; H04B 10/6931

(57) ABSTRACT

An optical transmitter includes a driver amplifier, a superimpose, an optical modulator, a detector and a controller. The driver amplifier amplifies a high-frequency signal. The addition processor adds a dither signal to the high-frequency signal amplified by the driver amplifier. The optical modulator modulates an optical signal according to the high-frequency signal to which the dither signal is added. The detector detects a fluctuation level of the dither signal from the modulated optical signal. The controller controls a gain of the driver amplifier that amplifies the high-frequency signal so that an output amplitude of the driver amplifier is constant based on the detected fluctuation level of the dither signal.

### CROSS-REFERENCE TO RELATED APPLICATION

This application is based upon and claims the benefit of priority of the prior Japanese Patent Application No. 2024-055775, filed on Mar. 29, 2024, the entire contents of which are incorporated herein by reference.

### FIELD

The embodiment discussed herein is related to an optical transmitter and an optical transceiver.

### BACKGROUND

At present, the demand for network traffic is increasing at home and abroad, and it is expected that the progress of 5G will further increase the speed and capacity of the edge network. In view of this situation, further improvement of the transmission capacity is desired in the future in Japan and other countries.

Therefore, in the optical transmission system, the transmission capacity has been increased, and a transmission rate exceeding 1 tera bps (bits per second) per wavelength is expected to be put to practical use in the future. As a means for improving the transmission capacity, there are known a high multi-level for increasing the information length per symbol (code) and a high symbol rate for increasing the number of symbols per unit time.

In order to realize such a high multi-level and a high symbol rate, an optical device such as an E/O converter that converts an electrical signal into an optical signal at a high speed and an optical device such as an O/E converter that converts an optical signal into an electrical signal are important. The improvement of the transmission capacity largely depends on the speed-up of these devices, but the demand for an increase in the transmission capacity of the devices is stronger than the speed-up of the devices, and the devices having a slightly insufficient band are actually used by performing optimization adjustment such as band compensation. Moreover, in recent years, in such optimization adjustment, the degree of difficulty has increased due to a high multi-level and a high symbol rate, and the number of adjustment points also tends to increase.
Patent Literature 1: International Publication Pamphlet No. WO 2018/180537
Patent Literature 2: U.S. Pat. No. 9,124,364

As one of the adjustment points, there is gain adjustment of a driver amplifier in a coherent driver modulator (CDM). However, the driver amplifier used in the E/O converter is desired to suppress amplitude fluctuation due to temperature change.

FIG. 15 is an explanatory diagram illustrating an example of characteristics of a peak indicator (PI) value and a gain of the driver amplifier at an environmental temperature of 25° C. The PI value is the sensitivity of the output amplitude monitor of the driver amplifier. As illustrated in FIG. 15, the PI value greatly varies depending on the gain setting range of the driver amplifier. Note that the XI channel is a channel of the I component of the X polarized wave, the XQ channel is a channel of the Q component of the X polarized wave, the YI channel is a channel of the I component of the Y polarized wave, and the YQ channel is a channel of the Q component of the Y polarized wave. The target PI value of each channel is as illustrated in FIG. 15.

For example, when the gain of the driver amplifier is in the range of 0≤X≤64, the PI value of each channel is low, and the sensitivity of the output amplitude monitor is low. When the gain is in the range of 64<X≤128, the PI value of each channel is high, and the sensitivity of the output amplitude monitor is high. Focusing on the characteristics illustrated in FIG. 15, the gain corresponding to the target PI value of each channel of XI, XQ, YI, and YQ is around 80.

On the other hand, when the environmental temperature of the driver amplifier increases, the sensitivity of the output amplitude monitor greatly fluctuates. FIG. 16 is an explanatory diagram illustrating an example of characteristics of a PI value and a gain of the driver amplifier at an environmental temperature of 50° C. At a high environmental temperature of 50° C., the PI value increases even when the gain is small, and thus exceeds the target PI value of each channel. Therefore, the PI value will not be adjusted by adjusting the gain. As illustrated in FIG. 16, for example, the PI value of each channel of XI, XQ, and YI can be adjusted, but the PI value of the channel of YQ is not be adjusted.

Therefore, since the gain adjustment of the driver amplifier in the E/O converter is controlled using the electrical signal in the electric stage, there is a problem of fluctuation due to the temperature characteristic of the PI value itself, and it is difficult to stabilize the light output. Therefore, as the gain adjustment of the driver amplifier, for example, there is a demand for a method capable of stabilizing the optical output of the optical transmitter even in a case where the environmental temperature fluctuates using the optical output of the optical stage in the optical transmitter instead of the electric stage.

### SUMMARY

According to an aspect of an embodiment, an optical transmitter includes a driver amplifier, a superimpose, an optical modulator, a detector and a controller. The driver amplifier amplifies a high-frequency signal. The addition processor adds a dither signal to the high-frequency signal amplified by the driver amplifier. The optical modulator modulates an optical signal according to the high-frequency signal to which the dither signal is added. The detector detects a fluctuation level of the dither signal from the modulated optical signal. The controller controls a gain of the driver amplifier that amplifies the high-frequency signal so that an output amplitude of the driver amplifier is constant based on the detected fluctuation level of the dither signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical transceiver according to the present embodiment;

FIG. 2 is an explanatory diagram illustrating an example of an optical transmitter according to the first embodiment;

FIG. 3 is an explanatory diagram illustrating an example of an output of the driver amplifier according to the first embodiment;

FIG. 4 is an explanatory diagram illustrating an example of an optical output level according to a second dither signal and a fluctuation level of the second dither signal of the optical modulation unit according to the first embodiment;

FIG. 5 is a flowchart illustrating an example of the processing operation of a control unit related to the control process of the optical modulation unit;

FIG. 6A is a flowchart illustrating an example of the processing operation of an ABC control unit related to an ABC control process of the optical modulation unit;

FIG. 6B is a flowchart illustrating an example of the processing operation of the ABC control unit related to the ABC control process of the optical modulation unit;

FIG. 7A is a flowchart illustrating an example of the processing operation of a DRV control unit related to a first DRV control process of an optical modulation unit;

FIG. 7B is a flowchart illustrating an example of the processing operation of the DRV control unit related to the first DRV control process of the optical modulation unit;

FIG. 8 is an explanatory diagram illustrating an example of an optical transmitter according to the second embodiment;

FIG. 9 is an explanatory diagram illustrating an example of an optical output level and a first fluctuation level according to a first dither signal, and an optical output level and a second fluctuation level according to a second dither signal of an optical modulation unit according to the second embodiment;

FIG. 10A is a flowchart illustrating an example of the processing operation of the DRV control unit related to a second DRV control process of the optical modulation unit;

FIG. 10B is a flowchart illustrating an example of the processing operation of the DRV control unit related to the second DRV control process of the optical modulation unit;

FIG. 11 is an explanatory diagram illustrating an example of an optical transmitter of the third embodiment;

FIG. 12 is an explanatory diagram illustrating an example of an optical output level and a first fluctuation level according to a first dither signal of an optical modulation unit of the third embodiment;

FIG. 13 is an explanatory diagram illustrating an example of an optical output level and a second fluctuation level according to a second dither signal of the optical modulation unit of the third embodiment;

FIG. 14A is a flowchart illustrating an example of the processing operation of the DRV control unit related to a third DRV control process of the optical modulation unit;

FIG. 14B is a flowchart illustrating an example of the processing operation of the DRV control unit related to the third DRV control process of the optical modulation unit;

FIG. 15 is an explanatory diagram illustrating an example of characteristics of a PI value and a gain of a driver amplifier at an environmental temperature of 25° C.; and

FIG. 16 is an explanatory diagram illustrating an example of characteristics of a PI value and a gain of a driver amplifier at an environmental temperature of 50° C.

### DESCRIPTION OF EMBODIMENTS

Preferred embodiments of the present invention will be explained with reference to accompanying drawings. Note that the disclosed technology is not limited by the present embodiment. In addition, the following embodiments may be appropriately combined as long as there is no contradiction.

### (a) First Embodiment

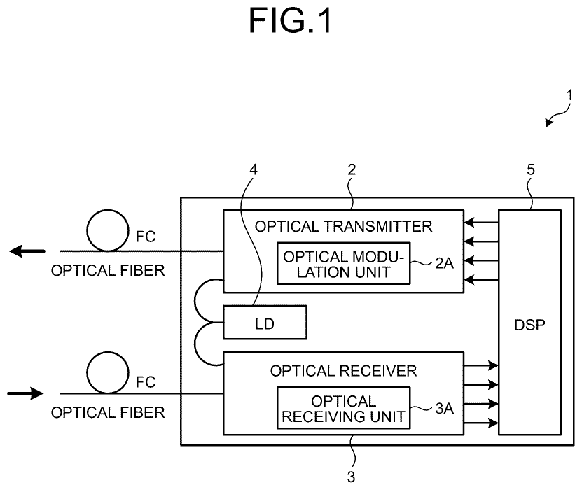

FIG. 1 is an explanatory diagram illustrating an example of an optical transceiver 1 according to the present embodiment. The optical transceiver 1 illustrated in FIG. 1 is, for example, a DP-QPSK (Dual Polarization-Quadrature Phase Shift Keying: polarization multiplexing quadrature phase shift) coherent optical transceiver. The optical transceiver 1 includes an optical transmitter 2, an optical receiver 3, a laser diode (LD) 4, and a digital signal processor (DSP) 5. The optical transmitter 2 includes an optical modulation unit 2A that modulates the optical signal from the LD 4 according to the electrical signal from the DSP 5, and outputs transmission light modulated by the optical modulation unit 2A from the optical fiber FC. The optical receiver 3 includes an optical reception unit 3B that acquires reception light from signal light received from an optical fiber using an optical signal from the LD 4 and converts a reception signal of an electrical signal from the acquired reception light, and outputs the reception signal of the electrical signal to the DSP 5. The LD 4 is a light source that emits an optical signal. The DSP 5 is a signal processing unit that generates an electrical signal to the optical transmitter 2 based on data and acquires data from a reception signal from the optical receiver 3.

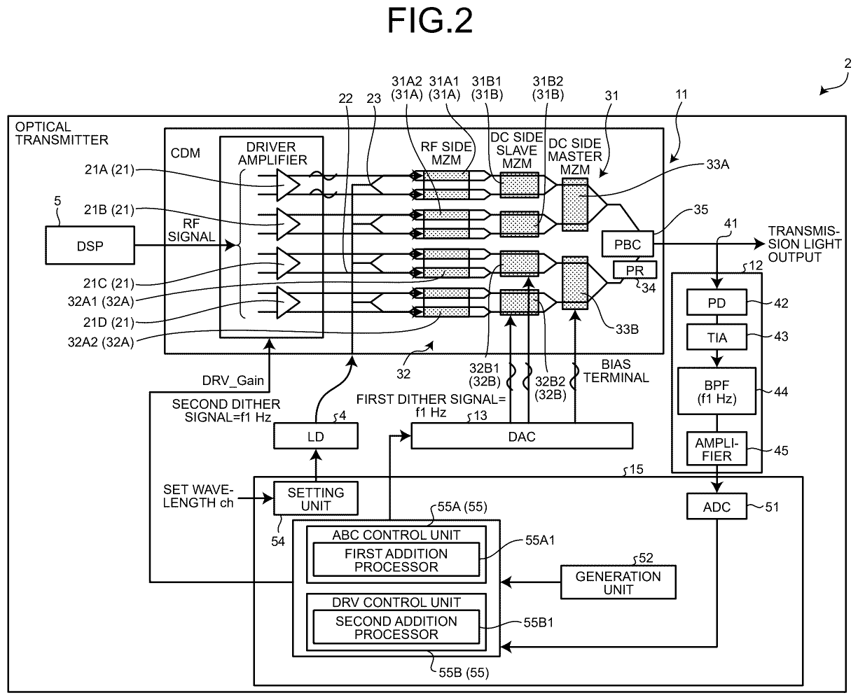

FIG. 2 is an explanatory diagram illustrating an example of the optical transmitter 2 according to the first embodiment. The optical transmitter 2 includes a coherent driver modulator (CDM) 11, a detection unit 12, a digital analog convertor (DAC) 13, and a microcomputer 15. The CDM 11 includes a driver amplifier 21 provided for each channel and an optical modulation unit 2A. The driver amplifier 21 is an amplifier that amplifies an RF signal that is a high-frequency signal output to the phase modulation unit in the optical modulation unit 2A. The driver amplifier 21 includes a driver amplifier 21A of an Xi channel that is the I component of the X polarized wave, and a driver amplifier 21B of an Xq channel that is the Q component of the X polarized wave. In addition, the driver amplifier 21 includes a driver amplifier 21C of a Yi channel that is the I component of the Y polarized wave and a driver amplifier 21D of a Yq channel that is the Q component of the Y polarized wave.

The optical modulation unit 2A includes a first branching unit 22, a second branching unit 23, an X polarized wave modulation unit 31, a Y polarized wave modulation unit 32, a polarization rotator (PR) 34, and a polarization beam combiner (PBC) 35. The first branching unit 22 branches and outputs the optical signal from the LD 4 to the second branching unit 23. The second branching unit 23 branches and outputs the optical signal from the first branching unit 22 to the X polarized wave modulation unit 31 and the Y polarized wave modulation unit 32.

The X polarized wave modulation unit 31 includes two RF side MZMs 31A, two DC side slave MZMs 31B, and one DC side master MZM 33A. The RF side MZM 31A is, for example, a phase modulation unit that phase-modulates the optical signal according to the RF signal from the driver amplifier 21 of the X channel. The DC side slave MZM 31B and the DC side master MZM 33A are, for example, phase adjustment units that adjust the phase of the X channel optical signal after the phase modulation.

The RF side MZM 31A1 of the Xi channel in the X polarized wave modulation unit 31 is, for example, a phase modulation unit of the Xi channel that phase-modulates the I component of the X polarized wave of the optical signal according to the RF signal from the driver amplifier 21A of the Xi channel. The DC side slave MZM 31B1 of the Xi channel in the X polarized wave modulation unit 31 is, for example, a phase adjustment unit of the Xi channel that adjusts the phase of the optical signal of the I component of the X polarized wave after the phase modulation according to the bias signal from the DAC 13. The DC side slave MZM 31B1 of the Xi channel outputs the optical signal of the I component of the X polarized wave after the phase adjustment to the DC side master MZM 33A.

The RF side MZM 31A2 of the Xq channel in the X polarized wave modulation unit 31 is, for example, a phase modulation unit of the Xq channel that phase-modulates the Q component of the X polarized wave of the optical signal according to the RF signal from the driver amplifier 21B of the Xq channel. Further, the DC side slave MZM 33B2 of the Xq channel in the X polarized wave modulation unit 31 is, for example, a phase adjustment unit of the Xq channel that adjusts the phase of the optical signal of the Q component of the X polarized wave after the phase modulation according to the bias signal from the DAC 13. The DC side slave MZM 31B2 of the Xq channel outputs the optical signal of the Q component of the X polarized wave after the phase adjustment to the DC side master MZM 33A.

The DC side master MZM 33A in the X polarized wave modulation unit 31 is, for example, a phase adjustment unit of an Xphi channel that orthogonally modulates the optical signal of the I component of the X polarized wave after the phase adjustment and the optical signal of the Q component of the X polarized wave after the phase adjustment according to the bias signal from the DAC 13. The DC side master MZM 33A multiplexes the optical signal of the I component of the X polarized wave after the orthogonal modulation and the optical signal of the Q component of the X polarized wave after the orthogonal modulation to output the multiplexed optical signal of the X polarized wave to the PBC 35.

The Y polarized wave modulation unit 32 includes two RF side MZMs 32A, two DC side slave MZMs 32B, and one DC side master MZM 33B. The RF side MZM 32A is, for example, a phase modulation unit of the Y channel that phase-modulates an optical signal according to an RF signal from the Y channel driver amplifier 21. The DC SIDE slave MZM 32B and the DC side master MZM 33B are, for example, phase adjustment units of the Y channel that adjust the phase of the optical signal after the phase modulation.

The RF side MZM 32A1 of the Yi channel in the Y polarized wave modulation unit 32 is, for example, a phase modulation unit of the Yi channel that phase-modulates the I component of the Y polarized wave of the optical signal according to the RF signal from the driver amplifier 21C of the Yi channel. The DC side slave MZM 32B1 of the Yi channel in the Y polarized wave modulation unit 32 is, for example, a phase adjustment unit of the Yi channel that adjusts the phase of the optical signal of the I component of the Y polarized wave after the phase modulation according to the RF signal from the driver amplifier 21C of the Yi channel. The DC side slave MZM 32B1 of the Yi channel outputs the optical signal of the I component of the Y polarized wave after the phase adjustment to the DC side master MZM 33B.

The RF side MZM 32A2 of the Yq channel in the Y polarized wave modulation unit 32 is, for example, a phase modulation unit of the Yq channel that phase-modulates the Q component of the Y polarized wave of the optical signal according to the RF signal from the driver amplifier 21D of the Yq channel. Furthermore, the DC side slave MZM 32B2 of the Yq channel in the Y polarized wave modulation unit 32 is, for example, a phase adjustment unit of the Yq channel that adjusts the phase of the optical signal of the Q component of the Y polarized wave after the phase modulation according to the bias signal from the DAC 13. The DC side slave MZM 32B2 of the Yq channel outputs the Q component optical signal after the phase adjustment to the DC side master MZM 33B in the Y polarized wave modulation unit 32.

The DC side master MZM 33B in the Y polarized wave modulation unit 32 is, for example, a phase adjustment unit of a Yphi channel that orthogonally modulates the optical signal of the I component of the Y polarized wave after the phase adjustment and the optical signal of the Q component of the Y polarized wave after the phase adjustment according to the bias signal from the DAC 13. The DC side master MZM 33B multiplexes the optical signal of the I component of the Y polarized wave after the orthogonal modulation and the optical signal of the Q component of the Y polarized wave after the orthogonal modulation to output the multiplexed optical signal of the Y polarized wave to the PR 34.

The PR 34 polarization-rotates the optical signal of the Y polarized wave by 90 degrees to output the optical signal of the Y polarized wave component after the polarization rotation to the PBC 35. The PBC 35 polarization-multiplexes the optical signal of the X polarized wave component from the X polarized wave modulation unit 31 and the optical signal of the Y polarized wave component after 90 degree polarization rotation from the PR 34 to output the polarization-multiplexed optical signal to an optical fiber as transmission light.

The detection unit 12 includes a branch coupler 41, a photo detector (PD) 42, a transimpedance amplifier (TIA) 43, a band pass filter (BPF) 44, and an amplifier 45. The branch coupler 41 branches part of the polarization multiplexed optical signal that is the output of the optical modulation unit 2A. The PD 42 converts the optical signal partially branched by the branch coupler 41 into an electrical signal. The TIA 43 amplifies the electrical signal after the electrical conversion to output the amplified electrical signal to the BPF 44. The BPF 44 extracts a component of the electrical signal of the specific frequency from the amplified electrical signal. For example, in a case of f1 Hz, the filter frequency of the BPF 44 corresponds to a component of an electrical signal of a dither signal which is a low-frequency component to be described later. The amplifier 45 amplifies the component of the dither signal extracted by the BPF 44 to output the amplified component of the dither signal to the microcomputer 15.

The microcomputer 15 includes an analog digital convertor (ADC) 51, a generation unit 52, a setting unit 54, and a control unit 55. The ADC 51 digitally converts the component of the dither signal amplified by the amplifier 45. The generation unit 52 generates a predetermined dither signal. The setting unit 54 changes the setting of the wavelength of the optical signal output from the LD 4.

The control unit 55 controls the entire microcomputer 15. The control unit 55 includes an auto bias control (ABC) control unit 55A and a driver (DRV) control unit 55B. The ABC control unit 55A executes an ABC control process for each channel. The ABC control process is a process of adjusting the bias signals of the DC side slave MZMs 31B and 32B and the DC side master MZMs 33A and 33B for each channel to optimum bias points. The ABC control unit 55A includes a first addition processor 55A1 that adds the first dither signal to the bias signal. The first dither signal is, for example, an electrical signal of f1 Hz.

The DRV control unit 55B executes a DRV control process of the driver amplifier 21 for each channel. The DRV control process is a process of adjusting the optimum gain of the driver amplifier 21 for each channel. The DRV control unit 55B includes a second addition processor 55B1 that adds the second dither signal to the RF signal. The second dither signal is an electrical signal having a frequency same as that of the first dither signal, for example, f1 Hz.

In a case where the optical output of the optical transmitter 2 is on, the ABC control unit 55A outputs, to the DAC 13, a bias value obtained by adding the first dither signal to the bias signal applied to each of the DC side slave MZMs 31B and 32B. The DAC 13 analog-converts the bias value into a bias signal to which the first dither signal is added to output the analog-converted bias signal to the DC side slave MZMs 31B and 32B. The ABC control unit 55A detects a component of the first dither signal from the optical output power with respect to the first dither signal through the detection unit 12. The ABC control unit 55A executes ABC control of adjusting bias signals of the DC side slave MZMs 31B and 32B while searching for optimum bias points of the DC side slave MZMs 31B and 32B so that a component of the detected first dither signal is minimized. That is, the ABC control unit 55A executes the ABC control of sequentially adjusting the bias signals of the DC side slave MZMs 31B and 32B for each channel, adjusting the bias signals of all the DC side slave MZMs 31B and 32B, and then sequentially adjusting the bias signals for each of the DC side master MZMs 33A and 33B. The ABC control unit 55A can adjust the bias signals of the DC side slave MZMs 31B and 32B and the DC side master MZMs 33A and 33B to optimum bias points by executing the ABC control on the DC side slave MZMs 31B and 32B and the DC side master MZMs 33A and 33B.

The DRV control unit 55B executes the ABC control on the DC side slave MZMs 31B and 32B and the DC side master MZMs 33A and 33B, and then starts the DRV control on the driver amplifier 21 for each channel. The DRV control unit 55B sets the gain of the RF signal and the second dither signal of the low-frequency component to the driver amplifier 21 for each channel. Note that the gain is a gain adjustment amount of the driver amplifier 21 at which the signal quality is optimized. The gain of the driver amplifier 21 varies, for example, according to a change in environmental temperature. Therefore, in a case where the second dither signal is added to the RF signal, a fluctuation level which is a component of the second dither signal also changes in accordance with a change in the environmental temperature as in the gain. That is, when the gain of the driver amplifier 21 decreases, the fluctuation level also decreases, and when the gain of the driver amplifier 21 increases, the fluctuation level also increases.

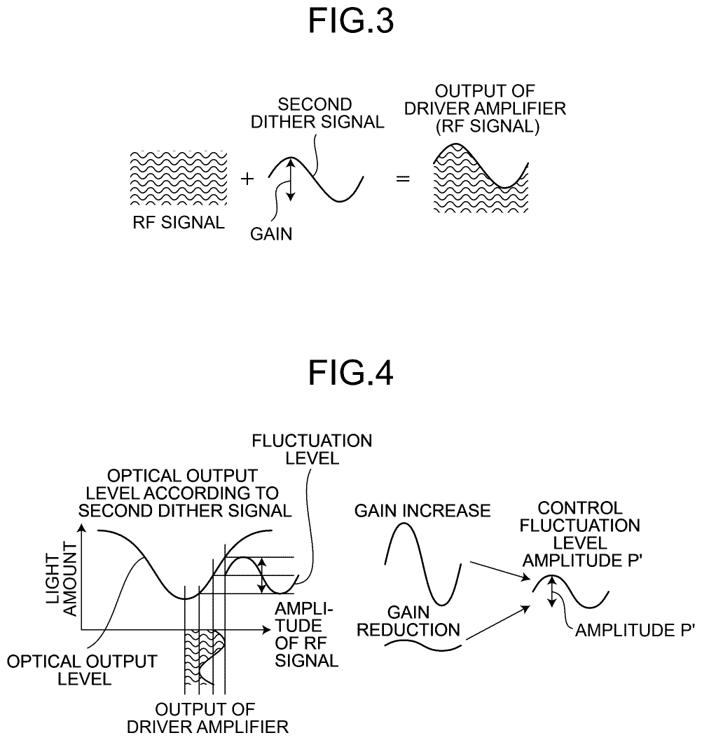

FIG. 3 is an explanatory diagram illustrating an example of an output of the driver amplifier 21 of the first embodiment. The driver amplifier 21 of each channel performs gain adjustment on the RF signal from the DSP 5 based on the gain for each channel set by the DRV control unit 55B. The driver amplifier 21 amplitude-modulates the gain-adjusted RF signal with the second dither signal having the constant amplitude, using the I and Q control axes (with reference to the extinction point) after the ABC control as reference axes, as illustrated in FIG. 3. The RF side MZM 31A phase-modulates the optical signal from the LD 4 according to the RF signal amplitude-modulated by the second dither signal. That is, the second dither signal having the amplitude P is converted into the level variation of the optical output power by the RF side MZM 31A. The DRV control unit 55B stores the fluctuation level P′ of the second dither signal of each channel after the optimization adjustment is performed as a predetermined fluctuation level that is a reference of each channel. Note that the optimization adjustment is adjustment of the bias signal of the ABC control described above.

Then, the DRV control unit 55B detects, through detection unit 12, the fluctuation level of the second dither signal that is the amplitude of the electrical signal according to the optical output power for the second dither signal. The DRV control unit 55B executes DRV control of adjusting the gain of the driver amplifier 21 so that the detected fluctuation level is a predetermined fluctuation level.

FIG. 4 is an explanatory diagram illustrating an example of an optical output level by a second dither signal and a fluctuation level of the second dither signal of the optical modulation unit 2A according to the first embodiment. In FIG. 4, the optical output level by the second dither signal is the optical output of the optical modulation unit 2A with the vertical axis representing the light amount and the horizontal axis representing the amplitude of the RF signal. The DRV control unit 55B can acquire the fluctuation level of the second dither signal from the optical output level through detection unit 12. By adjusting the gain of the driver amplifier 21 in the increasing direction or the decreasing direction, the fluctuation level of the second dither signal can be adjusted to a predetermined fluctuation level P′.

That is, the DRV control unit 55B FB-controls the gain of the driver amplifier 21 for each channel so that the fluctuation level of the second dither signal for each channel detected by the detection unit 12 is a predetermined fluctuation level. As a result, it is possible to perform control so that the output amplitude of the driver amplifier 21 is constant.

Then, the control unit 55 sequentially adjusts the gains of driver amplifiers 21 for each channel, adjusts the gains of all driver amplifiers 21, and then executes the ABC control process again. That is, the control unit 55 can ensure stable and highly accurate signal quality by repeatedly executing the ABC control process and the DRV control process.

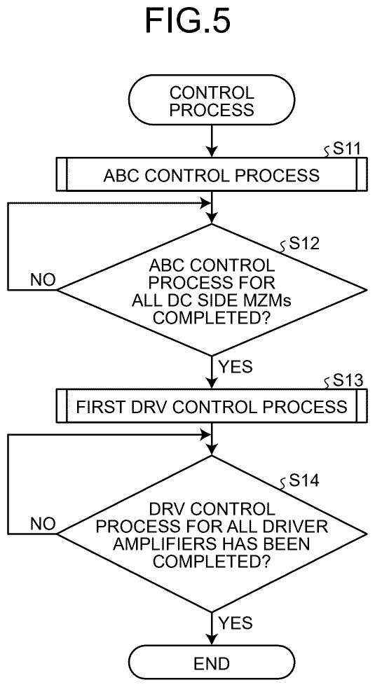

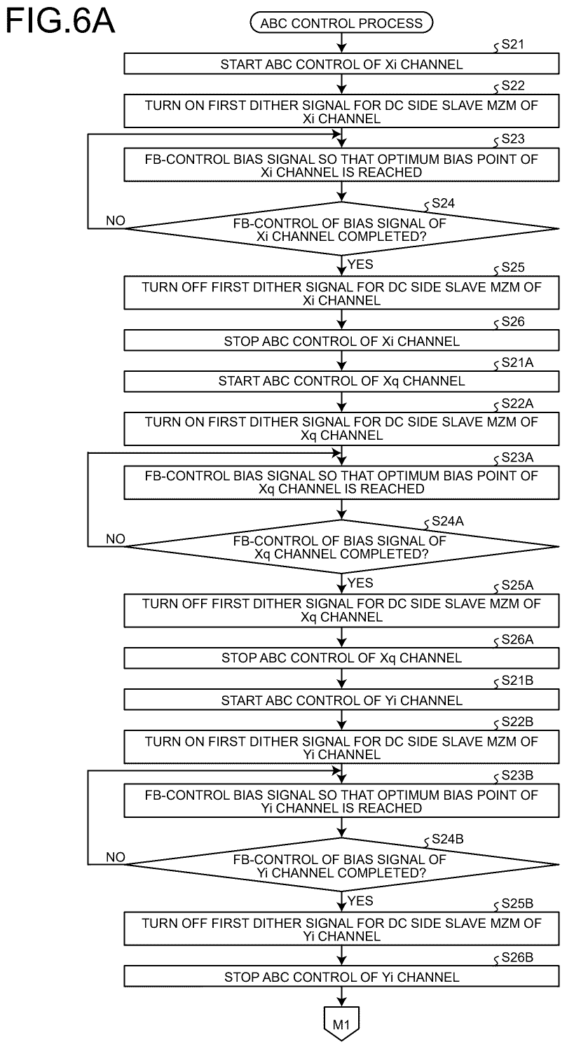

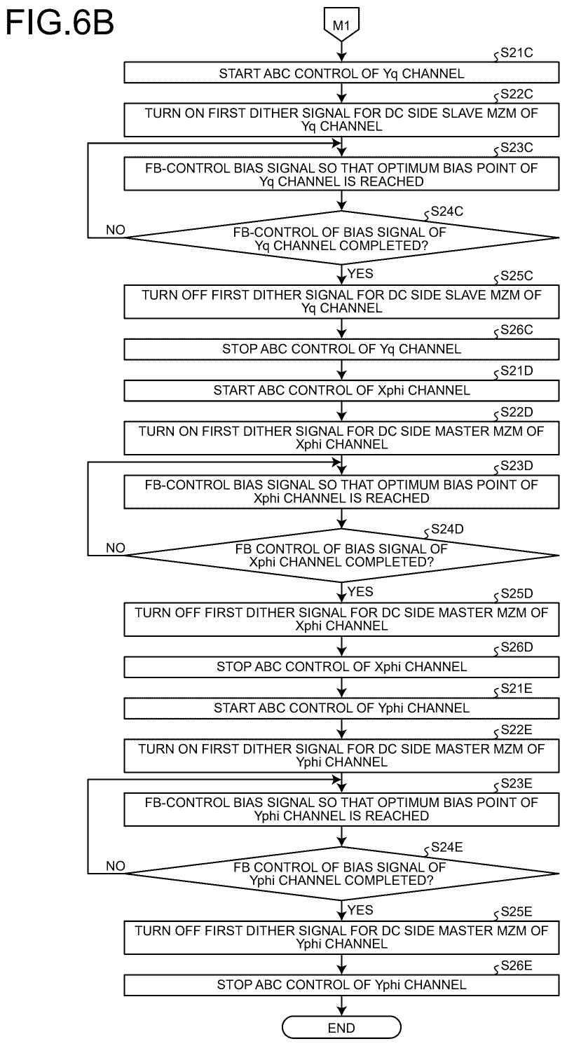

FIG. 5 is a flowchart illustrating an example of the processing operation of the control unit 55 related to the control process of the optical modulation unit 2A. The ABC control unit 55A in the control unit 55 executes, for example, an ABC control process at regular intervals (Step S11). Note that the ABC control process is a process illustrated in FIGS. 6A and 6B described later. After executing the ABC control process, the control unit 55 determines whether the ABC control process for all the DC side slave MZMs 31B and 32B and the DC side master MZMs 33A and 33B has been completed (Step S12).

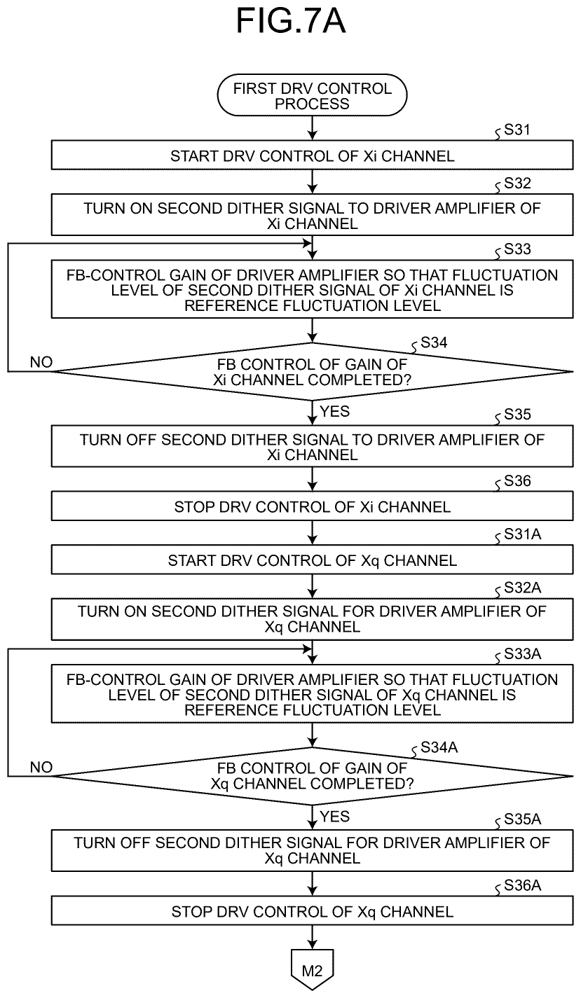

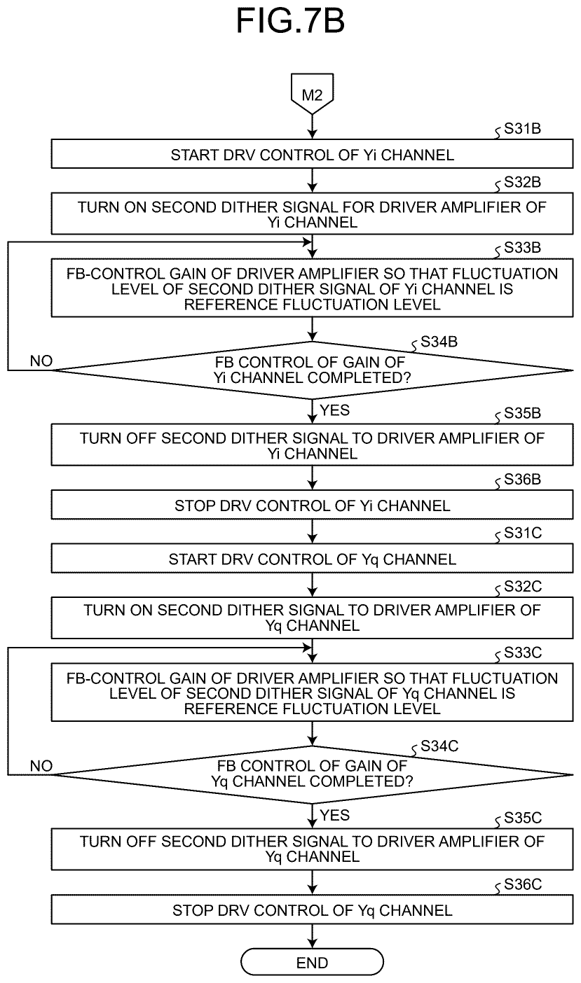

In a case where the ABC control process for all the DC side slave MZMs 31B and 32B and the DC side master MZMs 33A and 33B has been completed (Step S12: Yes), the DRV control unit 55B executes the first DRV control process for all the driver amplifiers 21 (Step S13). Note that the first DRV control process is a process illustrated in FIGS. 7A and 7B described later. The control unit 55 determines whether the first DRV control process for all driver amplifiers 21 has been completed (Step S14).

In a case where the first DRV control process for all the driver amplifiers 21 is ended (Step S14: Yes), the control unit 55 advances the process to the process of Step S11 to execute the ABC control process.

In a case where the ABC control process for all the DC side slave MZMs 31B and 32B and the DC side master MZMs 33A and 33B has not been completed (Step S12: No), the control unit 55 returns the process to the process for Step S12 to determine whether the ABC control process has been completed.

In a case where the first DRV control process for all the driver amplifiers 21 has not been completed (Step S14: No), the control unit 55 returns the process to the process for Step S14 to determine whether the first DRV control process is ended.

In the control process illustrated in FIG. 5, after the ABC control process is performed for all the DC side slave MZMs 31B and 32B and the DC side master MZMs 33A and 33B, the first DRV control process is performed on all the driver amplifiers 21. As a result, the optical transmitter 2 can ensure stable and highly accurate signal quality.

FIGS. 6A and 6B are flow diagrams illustrating an example of the processing operation of the ABC control unit 55A related to the ABC control process of the optical modulation unit 2A. In FIG. 6A, the ABC control unit 55A starts the ABC control on the DC side slave MZM 31B1 of the Xi channel (Step S21). The first addition processor 55A1 in the ABC control unit 55A turns on the first dither signal to be added to the bias signal for the DC side slave MZM 31B1 of the Xi channel (Step S22). As a result, the DAC 13 analog-converts the bias value to which the first dither signal is added to output the bias signal to which the analog-converted first dither signal is added to the DC side slave MZM 31B1 of the Xi channel. The DC side slave MZM 31B1 of the Xi channel performs phase adjustment on the optical signal of the I component of the X polarized wave from the RF side MZM 31A1 of the Xi channel according to the bias signal to output the optical signal of the I component of the X polarized wave after the phase adjustment to the DC side master MZM 33A. Then, the detection unit 12 detects a component of the first dither signal of the Xi channel from an optical output level that is an optical signal including the first dither signal of the Xi channel from the output stage of the optical modulation unit 2A.

The ABC control unit 55A FB-controls the bias signal for the DC side slave MZM 31B1 of the Xi channel so that an optimum bias point at which the component of the first dither signal for the Xi channel is minimized is reached (Step S23). The ABC control unit 55A determines whether the FB control of the bias signal for the DC side slave MZM 31B1 of the Xi channel is completed (Step S24).

In a case where the FB control of the bias signal for the DC side slave MZM 31B1 of the Xi channel is completed (Step S24: Yes), the first addition processor 55A1 turns off the first dither signal to be added to the bias signal for the DC side slave MZM 31B1 (Step S25). Then, the ABC control unit 55A stops the ABC control on the DC side slave MZM 31B1 of the Xi channel (Step S26). In a case where the FB control of the bias signal for the DC side slave MZM 31B1 of the Xi channel is not completed (Step S24: No), the ABC control unit 55A returns the process to the process of Step S23 of FB-controlling the bias signal for the DC side slave MZM 31B1 of the Xi channel.

The ABC control unit 55A stops the ABC control on the DC side slave MZM 31B1 of the Xi channel, and then starts the ABC control on the DC side slave MZM 31B2 of the Xq channel (Step S21A). The first addition processor 55A1 turns on the first dither signal to be added to the bias signal for the DC side slave MZM 31B2 of the Xq channel (Step S22A). As a result, the DAC 13 analog-converts the bias signal to which the first dither signal is added to output the bias signal to which the analog-converted first dither signal is added to the DC side slave MZM 31B2 of the Xq channel. The DC side slave MZM 31B2 of the Xq channel adjusts the phase of the optical signal of the Q component of the X polarized wave from the RF side MZM 31A2 of the Xq channel according to the bias signal to output the optical signal of the Q component of the X polarized wave after the phase adjustment to the DC side master MZM 33A. Then, the detection unit 12 detects a component of the Xq channel first dither signal from an optical output level that is an optical signal including the Xq channel first dither signal from the output stage of the optical modulation unit 2A.

The ABC control unit 55A FB-controls the bias signal for the DC side slave MZM 31B2 of the Xq channel so that an optimum bias point at which the component of the first dither signal for the Xq channel is minimized is reached (Step S23A). The ABC control unit 55A determines whether the FB control of the bias signal for the DC side slave MZM 31B2 of the Xq channel is completed (Step S24A).

In a case where the FB control of the bias signal for the DC side slave MZM 31B2 of the Xq channel is completed (Step S24A: Yes), the first addition processor 55A1 turns off the first dither signal to be added to the bias signal for the DC side slave MZM 31B (Step S25A). Then, the ABC control unit 55A stops the ABC control on the DC side slave MZM 31B2 of the Xq channel (Step S26A). In a case where the FB control of the bias signal for the DC side slave MZM 31B2 of the Xq channel is not completed (Step S24A: No), the ABC control unit 55A returns the process to the process of Step S23A of FB-controlling the bias signal for the DC side slave MZM 31B2 of the Xq channel.

Furthermore, after stopping the ABC control on the DC side slave MZM 32B1 of the Yi channel, the ABC control unit 55A starts the ABC control on the DC side slave MZM 32B1 of the Yi channel (Step S21B). The first addition processor 55A1 turns on the first dither signal to be added to the bias signal for the DC side slave MZM 32B1 of the Yi channel (Step S22B). As a result, the DAC 13 analog-converts the bias signal to which the first dither signal is added to output the bias signal to which the analog-converted first dither signal is added to the DC side slave MZM 32B1 of the Yi channel. The DC side slave MZM 32B1 of the Yi channel adjusts the phase of the optical signal of the I component of the Y polarized wave from the RF side MZM 32A1 of the Yi channel according to the bias signal to output the optical signal of the I component of the Y polarized wave after the phase adjustment to the DC side master MZM 33B. Then, the detection unit 12 detects a component of the first dither signal of the Yi channel from an optical output level that is an optical signal including the first dither signal of the Yi channel from the output stage of the optical modulation unit 2A.

The ABC control unit 55A FB-controls the bias signal for the DC side slave MZM 32B1 of the Yi channel so that an optimum bias point at which the component of the first dither signal for the Yi channel is minimized is reached (Step S23B). The ABC control unit 55A determines whether the FB control of the bias signal for the DC side slave MZM 32B1 of the Yi channel is completed (Step S24B).

In a case where the FB control of the bias signal for the DC side slave MZM 32B1 of the Yi channel is completed (Step S24B: Yes), the first addition processor 55A1 turns off the first dither signal to be added to the bias signal for the DC side slave MZM 32B1 (Step S25B). Then, the ABC control unit 55A stops the ABC control on the DC side slave MZM 32B1 of the Yi channel (Step S26B), and advances the process to M1 illustrated in FIG. 6B. In a case where the FB control of the bias signal for the DC side slave MZM 32B1 of the Yi channel is not completed (Step S24B: No), the ABC control unit 55A returns the process to the process of Step S23B of FB-controlling the bias signal for the DC side slave MZM 32B1 of the Yi channel.

In M1 illustrated in FIG. 6B, the ABC control unit 55A stops the ABC control on the DC side slave MZM 32B2 of the Yq channel, and then starts the ABC control on the DC side slave MZM 32B2 of the Yq channel (Step S21C). The first addition processor 55A1 turns on the first dither signal to be added to the bias signal for the DC side slave MZM 32B2 of the Yq channel (Step S22C). As a result, the DAC 13 analog-converts the bias signal to which the first dither signal is added to output the bias signal to which the analog-converted first dither signal is added to the DC side slave MZM 32B2 of the Yq channel. The DC side slave MZM 32B2 of the Yq channel adjusts the phase of the optical signal of the Q component of the Y polarized wave from the RF side MZM 32A2 of the Yq channel according to the bias signal to output the optical signal of the Q component of the Y polarized wave after the phase adjustment to the DC side master MZM 33B. Then, the detection unit 12 detects a component of the first dither signal of the Yq channel from an optical output level that is an optical signal including the first dither signal of the Yq channel from the output stage of the optical modulation unit 2A.

The ABC control unit 55A FB-controls the bias signal for the DC side slave MZM 32B2 of the Yq channel so that an optimum bias point at which the component of the first dither signal for the Yq channel is minimized is reached (Step S23C). The ABC control unit 55A determines whether the FB control of the bias signal for the DC side slave MZM 32B2 of the Yq channel is completed (Step S24C).

In a case where the FB control of the bias signal for the DC side slave MZM 32B2 of the Yq channel is completed (Step S24C: Yes), the first addition processor 55A1 turns off the first dither signal to be added to the bias signal for the DC side slave MZM 32B2 (Step S25C). Then, the ABC control unit 55A stops the ABC control on the DC side slave MZM 32B2 of the Yq channel (Step S26C). In a case where the FB control of the bias signal for the DC side slave MZM 32B2 of the Yq channel is not completed (Step S24C: No), the ABC control unit 55A returns the process to the process of Step S23C of FB-controlling the bias signal for the DC side slave MZM 32B2 of the Yq channel.

The ABC control unit 55A stops the ABC control on the DC side slave MZM 32B2 of the Yq channel, and then starts the ABC control on the DC side master MZM 33A of the Xphi channel (Step S21D). Note that the Xphi channel is a channel of the X polarized wave. The first addition processor 55A1 turns on the first dither signal to be added to the bias signal for the DC side master MZM 33A of the Xphi channel (Step S22D). As a result, the DAC 13 analog-converts the bias signal to which the first dither signal is added to output the bias signal to which the analog-converted first dither signal is added to the DC side master MZM 33A of the Xphi channel. The DC side master MZM 33A of the Xphi channel multiplexes the optical signal from the DC side slave MZM 31B1 of the Xi channel and the optical signal from the DC side slave MZM 31B2 of the Xq channel, and adjusts the phase of the multiplexed signal light according to the bias signal. The DC side master MZM 33A of the Xphi channel outputs the optical signal after the phase adjustment to the PBC 35. Then, the detection unit 12 detects a component of the first dither signal of the Xphi channel from an optical output level that is an optical signal including the first dither signal of the Xphi channel from the output stage of the optical modulation unit 2A.

The ABC control unit 55A FB-controls the bias signal for the DC side master MZM 33A of the Xphi channel so that an optimum bias point at which the component of the first dither signal for the Xphi channel is minimized is reached (Step S23D). The ABC control unit 55A determines whether the FB control of the bias signal for the DC side master MZM 33A of the Xphi channel is completed (Step S24D).

In a case where the FB control of the bias signal for the DC side master MZM 33A of the Xphi channel is completed (Step S24D: Yes), the first addition processor 55A1 turns off the first dither signal to be added to the bias signal for the DC side master MZM 33A of the Xphi channel (Step S25D). Then, the ABC control unit 55A stops the ABC control on the DC side master MZM 33A of the Xphi channel (Step S26D). Furthermore, in a case where the FB control of the bias signal for the DC side master MZM 33A is not completed (Step S24D: No), the ABC control unit 55A returns the process to the process of Step S23D of FB-controlling the bias signal for the DC side master MZM 33A of the Xphi channel.

Furthermore, after stopping the ABC control on the DC side master MZM 33A of the Xphi channel, the ABC control unit 55A starts the ABC control on the DC side master MZM 33B of the Yphi channel (Step S21E). Note that the Yphi channel is a channel of the Y polarized wave. The first addition processor 55A1 turns on the first dither signal to be added to the bias signal for the DC side master MZM 33B of the Yphi channel (Step S22E). As a result, the DAC 13 analog-converts the bias signal to which the first dither signal is added to output the bias signal to which the analog-converted first dither signal is added to the DC side master MZM 33B of the Yphi channel. The DC side master MZM 33B of the Yphi channel multiplexes the optical signal from the DC side slave MZM 32B1 of the Yi channel and the optical signal from the DC side slave MZM 32B2 of the Yq channel, and adjusts the phase of the multiplexed optical signal according to the bias signal. The DC side master MZM 33B of the Yphi channel outputs the optical signal after the phase adjustment to the PR 34. Then, the detection unit 12 detects a component of the first dither signal of the Yphi channel from an optical output level that is an optical signal including the first dither signal of the Yphi channel from the output stage of the optical modulation unit 2A.

The ABC control unit 55A FB-controls the bias signal with respect to the DC side master MZM 33B of the Yphi channel so that an optimum bias point at which the component of the first dither signal for the Yphi channel is minimized is reached (Step S23E). The ABC control unit 55A determines whether the FB control of the bias signal for the DC side master MZM 33B of the Yphi channel is completed (Step S24E).

In a case where the FB control of the bias signal for the DC side master MZM 33B of the Yphi channel is completed (Step S24E: Yes), the first addition processor 55A1 turns off the first dither signal to be added to the bias signal for the DC side master MZM 33B (Step S25E). Then, the ABC control unit 55A stops the ABC control on the DC side master MZM 33B of the Yphi channel (Step S26E), and ends the process operation illustrated in FIG. 6B. Furthermore, in a case where the FB control of the bias signal for the DC side master MZM 33B is not completed (Step S24E: No), the ABC control unit 55A returns the process to the process of Step S23E of FB-controlling the bias signal for the DC side master MZM 33B of the Yphi channel.

In the ABC control process, the ABC control process is performed for all the DC side slave MZMs 31B and 32B and the DC side master MZMs 33A and 33B. As a result, the optical modulation unit 2A can adjust the bias signals of the DC side slave MZMs 31B and 32B and the DC side master MZMs 33A and 33B to the optimum bias points.

FIGS. 7A and 7B are flowcharts illustrating an example of the processing operation of the DRV control unit 55B related to the first DRV control process of the optical modulation unit 2A. In FIG. 7A, the DRV control unit 55B in the microcomputer 15 starts the DRV control on the driver amplifier 21A of the Xi channel (Step S31). The second addition processor 55B1 in the DRV control unit 55B turns on the second dither signal to be added to the RF signal for the driver amplifier 21A of the Xi channel (Step S32). As a result, the driver amplifier 21A amplitude-modulates the gain-adjusted RF signal with the second dither signal to output the amplitude-modulated RF signal to the RF side MZM 31A1 of the Xi channel. Then, the RF side MZM 31A1 of the Xi channel phase-modulates on the optical signal according to the RF signal of the Xi channel. The detection unit 12 detects a fluctuation level that is a component of the second dither signal of the Xi channel from an optical output level that is an optical signal phase-modulated with the RF signal including the second dither signal of the Xi channel from the output stage of the optical modulation unit 2A.

The DRV control unit 55B performs the FB control of adjusting the gain of the driver amplifier 21A of the Xi channel so that the fluctuation level that is a component of the second dither signal of the Xi channel is a reference fluctuation level (Step S33). The DRV control unit 55B determines whether the FB control of gain adjustment of the driver amplifier 21A of the Xi channel is completed (Step S34).

In a case where the FB control of gain adjustment of the driver amplifier 21A of the Xi channel is completed (Step S34: Yes), the second addition processor 55B1 turns off the second dither signal to be added to the RF signal for the driver amplifier 21A of the Xi channel (Step S35). Then, the DRV control unit 55B stops the DRV control on the driver amplifier 21A of the Xi channel (Step S36). In a case where the FB control of gain adjustment of the driver amplifier 21A of the Xi channel is not completed (Step S34: No), the DRV control unit 55B returns the process to the process of Step S33 for executing the FB control of adjusting the gain of the driver amplifier 21A of the Xi channel.

After stopping the DRV control on the driver amplifier 21A of the Xi channel, the DRV control unit 55B starts the DRV control on the driver amplifier 21B of the Xq channel (Step S31A). The second addition processor 55B1 turns on the second dither signal to be added to the RF signal for the driver amplifier 21B of the Xq channel (Step S32A). As a result, the driver amplifier 21B amplitude-modulates the gain-adjusted RF signal with the second dither signal to output the amplitude-modulated RF signal to the RF side MZM 31A2 of the Xq channel. Then, the RF side MZM 31A2 of the Xq channel phase-modulates on the optical signal according to the RF signal of the Xq channel. The detection unit 12 detects a fluctuation level that is a component of an Xq channel second dither signal from an optical output level that is an optical signal phase-modulated with an RF signal including the Xq channel second dither signal from an output stage of the optical modulation unit 2A.

The DRV control unit 55B executes FB control of adjusting the gain of the driver amplifier 21B of the Xq channel so that the fluctuation level that is the component of the second dither signal of the Xq channel is the reference fluctuation level (Step S33A). The DRV control unit 55B determines whether the FB control of the gain adjustment of the driver amplifier 21B of the Xq channel is completed (Step S34A).

In a case where the FB control of the gain adjustment of the driver amplifier 21B of the Xq channel is completed (Step S34A: Yes), the second addition processor 55B1 turns off the second dither signal to be added to the RF signal for the driver amplifier 21B (Step S35A). Then, the DRV control unit 55B stops the DRV control on the driver amplifier 21B of the Xq channel (Step S36A), and advances the process to the process of M2 illustrated in FIG. 7B. Further, in a case where the FB control of the gain adjustment of the driver amplifier 21B of the Xq channel is not completed (Step S34A: No), the DRV control unit 55B returns the process to the process of Step S33A of executing the FB control of adjusting the gain of the driver amplifier 21B of the Xq channel.

In M2 illustrated in FIG. 7B, after stopping the DRV control on the driver amplifier 21B of the Xq channel, the DRV control unit 55B starts the DRV control on the driver amplifier 21C of the Yi channel (Step S31B). The second addition processor 55B1 turns on the second dither signal to be added to the RF signal for the driver amplifier 21C of the Yi channel (Step S32B). As a result, the driver amplifier 21C amplitude-modulates the gain-adjusted RF signal with the second dither signal to output the amplitude-modulated RF signal to the RF side MZM 32A1 of the Yi channel. Then, the RF side MZM 32A1 of the Yi channel phase-modulates the optical signal according to the RF signal of the Yi channel. The detection unit 12 detects a fluctuation level that is a component of the second dither signal of the Yi channel from an optical output level that is an optical signal phase-modulated with the RF signal including the second dither signal of the Yi channel from the output stage of the optical modulation unit 2A.

The DRV control unit 55B executes FB control of adjusting the gain of the driver amplifier 21C of the Yi channel so that the fluctuation level that is the component of the second dither signal of the Yi channel is the reference fluctuation level (Step S33B). The DRV control unit 55B determines whether the FB control of the gain adjustment of the driver amplifier 21C of the Yi channel is completed (Step S34B).

In a case where the FB control of the gain adjustment of the driver amplifier 21C of the Yi channel is completed (Step S34B: Yes), the DRV control unit 55B turns off the second dither signal for the driver amplifier 21C of the Yi channel (Step S35B). Then, the DRV control unit 55B stops the DRV control on the driver amplifier 21C of the Yi channel (Step S36B). Further, in a case where the FB control of the gain adjustment of the driver amplifier 21C of the Yi channel is not completed (Step S34B: No), the DRV control unit 55B returns the process to the process of Step S33B for executing the FB control of adjusting the gain of the driver amplifier 21C of the Yi channel.

After stopping the DRV control on the driver amplifier 21C of the Yi channel, the DRV control unit 55B starts the DRV control on the driver amplifier 21D of the Yq channel (Step S31C). The second addition processor 55B1 turns on the second dither signal to be added to the RF signal for the driver amplifier 21D of the Yq channel (Step S32C). As a result, the driver amplifier 21D amplitude-modulates the gain-adjusted RF signal with the second dither signal to output the amplitude-modulated RF signal to the RF side MZM 32A2 of the Yq channel. Then, the RF side MZM 32A2 of the Yq channel phase-modulates on the optical signal according to the RF signal of the Yq channel.

The detection unit 12 detects a fluctuation level that is a component of the second dither signal of the Yq channel from an optical output level that is an optical signal phase-modulated with the RF signal including the second dither signal of the Yq channel from the output stage of the optical modulation unit 2A.

The DRV control unit 55B executes FB control of adjusting the gain of the driver amplifier 21D of the Yq channel so that the fluctuation level that is the component of the second dither signal of the Yq channel is the reference fluctuation level (Step S33C). The DRV control unit 55B determines whether the FB control of the gain adjustment of the driver amplifier 21D of the Yq channel is completed (Step S34C).

In a case where the FB control of the gain adjustment of the driver amplifier 21D of the Yq channel is completed (Step S34C: Yes), the second addition processor 55B1 turns off the second dither signal to be added to the RF signal for the driver amplifier 21D (Step S35C). Then, the DRV control unit 55B stops the DRV control on the driver amplifier 21D of the Yq channel (Step S36C), and ends the process operation illustrated in FIG. 7B. Further, in a case where the FB control of the gain adjustment of the driver amplifier 21D of the Yq channel is not completed (Step S34C: No), the DRV control unit 55B returns the process to the process of Step S33C for executing the FB control of adjusting the gain of the driver amplifier 21D of the Yq channel.

In the first DRV control process, after the ABC control process is executed, the gain of the driver amplifier 21 of each channel is adjusted so that the fluctuation level of the second dither signal for each channel is the reference fluctuation level. As a result, since the output amplitude of the driver amplifier 21 can be controlled to be constant, the optical output of the optical modulation unit 2A can be stabilized.

In the optical transmitter 2 according to the first embodiment, the gain of the driver amplifier 21 that amplifies the RF signal is controlled based on the fluctuation level of the second dither signal detected at the output stage of the optical modulation unit 2A. As a result, since the output amplitude of the driver amplifier 21 is constant, the optical output of the optical modulation unit 2A can be stabilized.

In the optical transmitter 2, the gain of the driver amplifier 21 is controlled so that the fluctuation level of the second dither signal detected at the output stage of the optical modulation unit 2A matches a predetermined fluctuation level set in advance. As a result, since the output amplitude of the driver amplifier 21 is constant, the optical output of the optical modulation unit 2A can be stabilized.

The optical transmitter 2 executes the ABC control of the DC side slave MZMs 31B and 32B and the DC side master MZMs 33A and 33B based on the fluctuation level of the first dither signal. Furthermore, after executing the ABC control, the optical transmitter 2 controls the gain of the driver amplifier 21 based on the fluctuation level of the second dither signal. As a result, the optical output of the optical modulation unit 2A can be stabilized while the bias signal of each channel is adjusted to the optimum bias point.

### (b) Second Embodiment

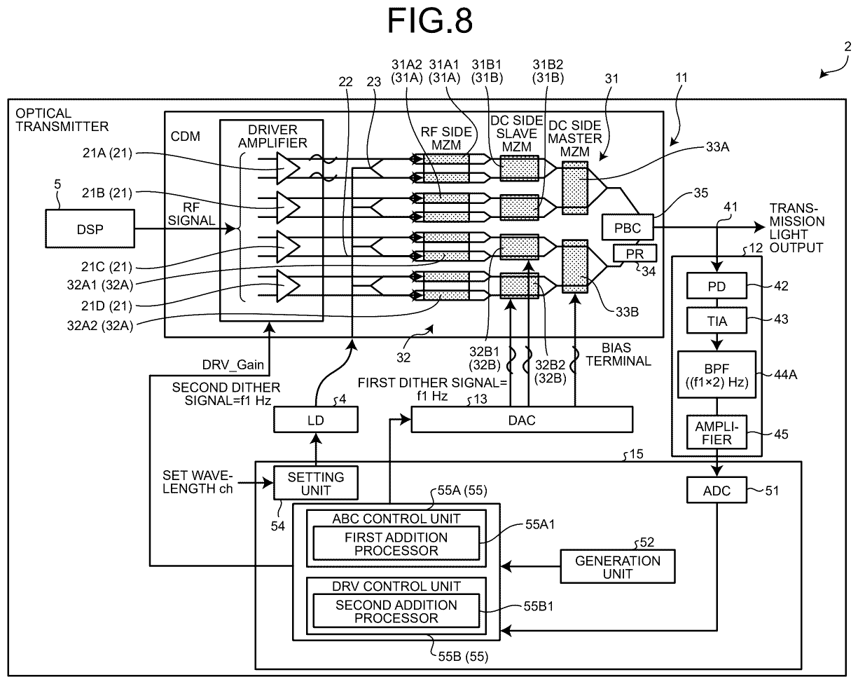

FIG. 8 is an explanatory diagram illustrating an example of the optical transmitter 2 according to the second embodiment. Note that the same components as those of the optical transmitter 2 according to the first embodiment are denoted by the same reference numerals, and the description of the overlapping components and operations will be omitted. The detection unit 12 illustrated in FIG. 8 has a BPF 44A having a filter frequency of f1×2 instead of the BPF 44 having a filter frequency of f1. The BPF 44A detects a component of the first dither signal and detects a component of the second dither signal having an opposite phase correlation with the first dither signal.

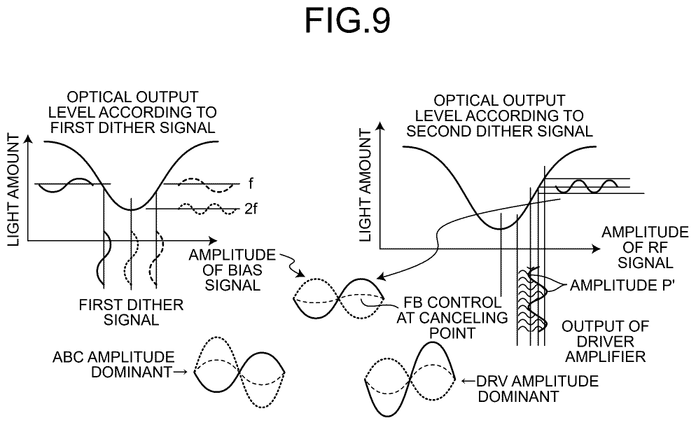

FIG. 9 is an explanatory diagram illustrating an example of an optical output level and a first fluctuation level according to a first dither signal, and an optical output level and a second fluctuation level according to a second dither signal of the optical modulation unit 2A according to the second embodiment. In FIG. 9, the optical output level according to the first dither signal is the optical output of the optical modulation unit 2A with the vertical axis representing the light amount and the horizontal axis representing the amplitude of the bias signal. The DRV control unit 55B can acquire the first fluctuation level that is the fluctuation level of the first dither signal from the optical output level through the detection unit 12. The optical output level according to the second dither signal is the optical output of the optical modulation unit 2A with the vertical axis representing the light amount and the horizontal axis representing the amplitude of the RF signal. The DRV control unit 55B can acquire the second fluctuation level that is the fluctuation level of the second dither signal from the optical output level through the detection unit 12.

The second dither signal and the first dither signal of the same channel have an opposite phase correlation. Therefore, in a case where the amplitudes of the first fluctuation level and the second fluctuation level match, the second fluctuation level will disappear.

However, in a case where the first fluctuation level is greater in amplitude than the second fluctuation level, they are not fully canceled out, leaving an amplitude component of the first fluctuation level. Also, in a case where the second fluctuation level has a larger amplitude compared to the first fluctuation level, they are not fully canceled out, leaving an amplitude component of the second fluctuation level.

Next, the operation of the optical transmitter 2 according to the second embodiment will be described. First, the ABC control unit 55A adjusts the bias values of the DC side slave MZMs 31B and 32B and the DC side master MZMs 33A and 33B to optimum bias values by performing ABC control on the DC side slave MZMs 31B and 32B and the DC side master MZMs 33A and 33B. That is, since the ABC control is stopped at the convergence point after the execution of the ABC control, the fluctuation level (f) of the first dither signal at the convergence point of the ABC control has a fixed value.

The DRV control unit 55B starts the DRV control for each channel after the ABC control unit 55A executes the ABC control of the DC side slave MZMs 31B and 32B and the DC side master MZMs 33A and 33B. The control unit 55 adjusts the first addition processor 55A1 and the second addition processor 55B1 for each channel so that the timing at which the second dither signal is added to the RF signal matches the timing at which the first dither signal is added to the bias signal. That is, the control unit 55 adjusts the addition timing of the dither signal of the first addition processor 55A1 and the second addition processor 55B1 so as to obtain the phase timing at which the second fluctuation level is canceled out with the first fluctuation level at the output stage of the optical modulation unit 2A.

The DRV control unit 55B adjusts the gain of the driver amplifier 21 for each channel in an adjustment process in which the communication quality of the output of the optical modulation unit 2A is optimized. Then, the DRV control unit 55B adjusts the gain of the driver amplifier 21 so that the second fluctuation level is completely canceled out with the first fluctuation level, and sets the completely canceled out gain as the adjustment amount. Note that the set adjustment amount is a fixed value. That is, if the gain does not fluctuate, the second fluctuation level does not change, and thus, the first fluctuation level and the second fluctuation level are completely canceled out.

Furthermore, for example, in a case where the gain of the driver amplifier 21 decreases according to the variation in the environmental temperature, the second fluctuation level also decreases according to the decrease in the gain. In this case, since the amplitude of the first fluctuation level is larger than that of the second fluctuation level, they are not fully canceled out, leaving an amplitude component of the first dither signal.

Furthermore, for example, in a case where the gain of the driver amplifier 21 increases in accordance with the variation in the environmental temperature, the second fluctuation level also increases in accordance with the increase in the gain. In this case, since the amplitude of the second fluctuation level is larger than that of the first fluctuation level, they are not fully canceled out, leaving an amplitude component of the second dither signal.

Therefore, even in a case where the gain of the driver amplifier 21 fluctuates, the DRV control unit 55B adjusts the gain of the driver amplifier 21 so that the first fluctuation level is completely canceled out with the second fluctuation level. As a result, it is possible to perform control so that the output amplitude of the driver amplifier 21 is constant.

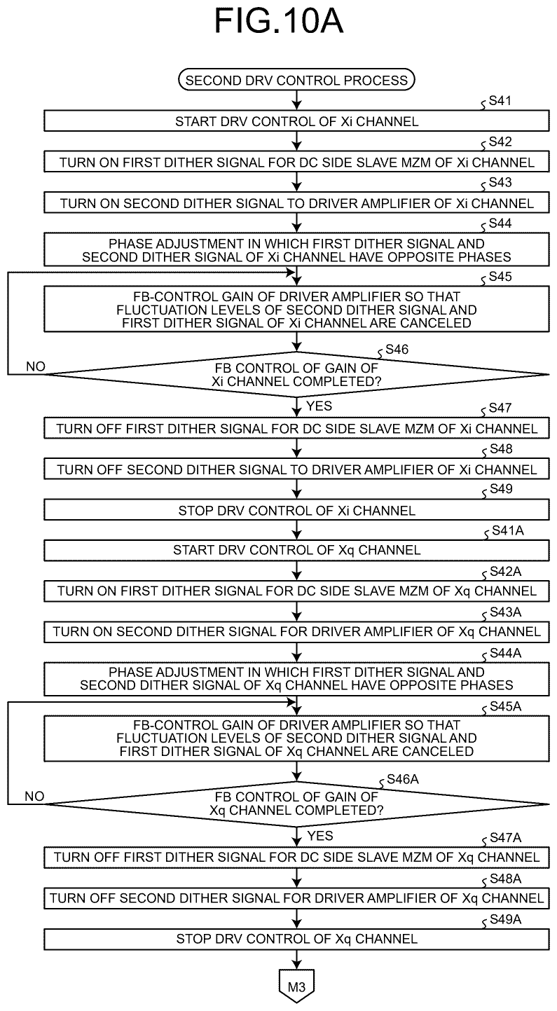

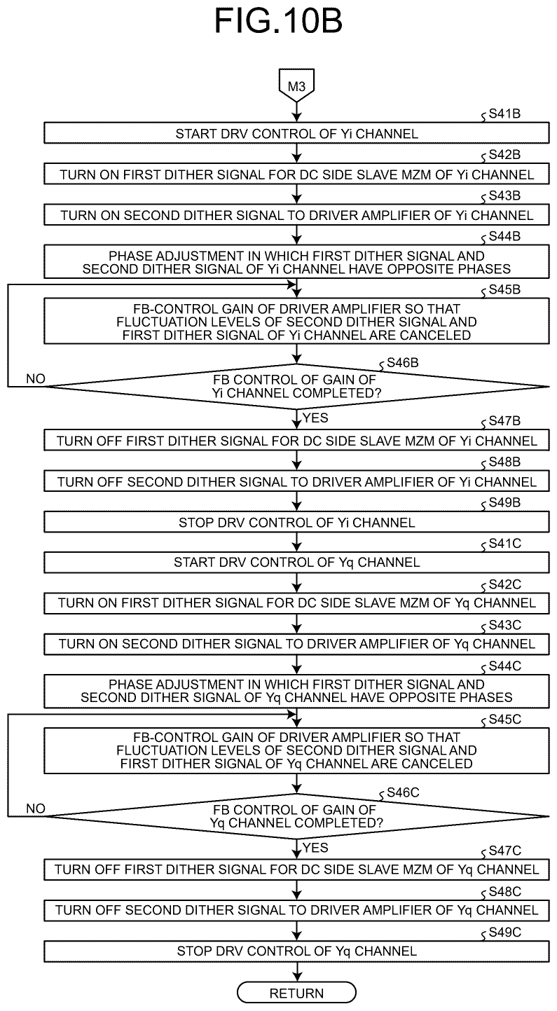

FIGS. 10A and 10B are flowcharts illustrating an example of the processing operation of the DRV control unit 55B related to the second DRV control process of the optical modulation unit 2A. In FIG. 10A, the DRV control unit 55B starts the DRV control on the driver amplifier 21A of the Xi channel (Step S41). The first addition processor 55A1 turns on the first dither signal to be added to the bias signal for the DC side slave MZM 31B1 of the Xi channel (Step S42). The second addition processor 55B1 turns on the second dither signal to be added to the RF signal for the driver amplifier 21A of the Xi channel (Step S43).

The control unit 55 performs phase adjustment so that the first dither signal to be added to the bias signal for the DC side slave MZM 31B1 of the Xi channel and the second dither signal to be added to the RF signal for the driver amplifier 21A of the Xi channel have opposite phases (Step S44). As a result, the driver amplifier 21A amplitude-modulates the gain-adjusted RF signal with the second dither signal to output the amplitude-modulated RF signal to the RF side MZM 31A1 of the Xi channel. Then, the RF side MZM 31A1 of the Xi channel phase-modulates on the optical signal according to the RF signal of the Xi channel. The detection unit 12 detects the first fluctuation level and the second fluctuation level of the Xi channel from the optical output level that is an optical signal from the output stage of the optical modulation unit 2A.

The DRV control unit 55B FB-controls the gain of the driver amplifier 21A of the Xi channel so that the first fluctuation level of the Xi channel and the second fluctuation level of the Xi channel are canceled out (Step S45). The DRV control unit 55B determines whether the FB control of the gain of the driver amplifier 21A of the Xi channel is completed (Step S46).

In a case where the FB control of the gain of the driver amplifier 21A of the Xi channel is completed (Step S46: Yes), the first addition processor 55A1 turns off the first dither signal to be added to the bias signal for the DC side slave MZM 31B1 of the Xi channel (Step S47). Furthermore, the second addition processor 55B1 turns off the second dither signal to be added to the RF signal for the driver amplifier 21A of the Xi channel (Step S48). Then, the DRV control unit 55B stops the DRV control on the driver amplifier 21A of the Xi channel (Step S49). In a case where the FB control of gain adjustment of the driver amplifier 21A of the Xi channel is not completed (Step S46: No), the DRV control unit 55B returns the process to the process of Step S45 for executing the FB control of adjusting the gain of the driver amplifier 21A of the Xi channel.

After stopping the DRV control on the driver amplifier 21A of the Xi channel, the DRV control unit 55B starts the DRV control on the driver amplifier 21B of the Xq channel (Step S41A). The first addition processor 55A1 turns on the first dither signal to be added to the bias signal for the DC side slave MZM 31B2 of the Xq channel (Step S42A). The second addition processor 55B1 turns on the second dither signal to be added to the RF signal for the driver amplifier 21B of the Xq channel (Step S43A).

The control unit 55 performs phase adjustment so that the first dither signal to be added to the bias signal for the DC side slave MZM 31B2 of the Xq channel and the second dither signal to be added to the RF signal for the driver amplifier 21B of the Xq channel have opposite phases (Step S44A). As a result, the driver amplifier 21B amplitude-modulates the gain-adjusted RF signal with the second dither signal to output the amplitude-modulated RF signal to the RF side MZM 31A2 of the Xq channel. Then, the RF side MZM 31A2 of the Xq channel phase-modulates on the optical signal according to the RF signal of the Xq channel. The detection unit 12 detects the first fluctuation level and the second fluctuation level of the Xq channel from the optical output level that is the optical signal from the output stage of the optical modulation unit 2A.

The DRV control unit 55B executes the FB control of the gain of the driver amplifier 21B of the Xq channel so that the first fluctuation level of the Xq channel and the second fluctuation level of the Xq channel are canceled out (Step S45A). The DRV control unit 55B determines whether the FB control of the gain of the driver amplifier 21B of the Xq channel is completed (Step S46A).

In a case where the FB control of the gain of the driver amplifier 21B of the Xq channel is completed (Step S46A: Yes), the first addition processor 55A1 turns off the first dither signal to be added to the bias signal for the DC side slave MZM 31B2 of the Xq channel (Step S47A). Further, the second addition processor 55B1 turns off the second dither signal to be added to the RF signal for the driver amplifier 21B of the Xq channel (Step S48A). Then, the DRV control unit 55B stops the DRV control on the driver amplifier 21B of the Xq channel (Step S49A), and advances the process to M3 illustrated in FIG. 10B. Further, in a case where the FB control of the gain adjustment of the driver amplifier 21B of the Xq channel is not completed (Step S46A: No), the DRV control unit 55B returns the process to the process of Step S45A of executing the FB control of adjusting the gain of the driver amplifier 21B of the Xq channel.

In M3 illustrated in FIG. 10B, after stopping the DRV control on the driver amplifier 21B of the Xq channel, the DRV control unit 55B starts the DRV control on the driver amplifier 21C of the Yi channel (Step S41B). The first addition processor 55A1 turns on the first dither signal to be added to the bias signal for the DC side slave MZM 32B1 of the Yi channel (Step S42B). The second addition processor 55B1 turns on the second dither signal to be added to the RF signal for the driver amplifier 21C of the Yi channel (Step S43B).

The control unit 55 performs phase adjustment so that the first dither signal to be added to the bias signal for the DC side slave MZM 31B of the Yi channel and the second dither signal to be added to the RF signal for the driver amplifier 21C of the Yi channel have opposite phases (Step S44B). As a result, the driver amplifier 21C amplitude-modulates the gain-adjusted RF signal with the second dither signal to output the amplitude-modulated RF signal to the RF side MZM 32A1 of the Yi channel. Then, the RF side MZM 32A1 of the Yi channel phase-modulates the optical signal according to the RF signal of the Yi channel. The detection unit 12 detects the first fluctuation level and the second fluctuation level of the Yi channel from the optical output level that is the optical signal from the output stage of the optical modulation unit 2A.

The DRV control unit 55B executes the FB control of the gain of the driver amplifier 21C of the Yi channel so that the first fluctuation level of the Yi channel and the second fluctuation level of the Yi channel are canceled out (Step S45B). The DRV control unit 55B determines whether the FB control of the gain of the driver amplifier 21C of the Yi channel is completed (Step S46B).

In a case where the FB control of the gain of the driver amplifier 21C of the Yi channel is completed (Step S46B: Yes), the first addition processor 55A1 turns off the first dither signal to be added to the bias signal for the DC side slave MZM 32B1 of the Yi channel (Step S47B). Furthermore, the second addition processor 55B1 turns off the second dither signal to be added to the RF signal for the driver amplifier 21C of the Yi channel (Step S48B). Then, the DRV control unit 55B stops the DRV control on the driver amplifier 21C of the Yi channel (Step S49B). Further, in a case where the FB control of the gain adjustment of the driver amplifier 21C of the Yi channel is not completed (Step S46B: No), the DRV control unit 55B returns the process to the process of Step S45B for executing the FB control of adjusting the gain of the driver amplifier 21C of the Yi channel.

After stopping the DRV control on the driver amplifier 21C of the Yi channel, the DRV control unit 55B starts the DRV control on the driver amplifier 21D of the Yq channel (Step S41C). The first addition processor 55A1 turns on the first dither signal to be added to the bias signal for the DC side slave MZM 32B2 of the Yq channel (Step S42C). The second addition processor 55B1 turns on the second dither signal to be added to the RF signal for the driver amplifier 21D of the Yq channel (Step S43C).

The control unit 55 performs phase adjustment so that the first dither signal to be added to the bias signal for the DC side slave MZM 32B2 of the Yq channel and the second dither signal to be added to the RF signal for the driver amplifier 21D of the Yq channel have opposite phases (Step S44C). As a result, the driver amplifier 21D amplitude-modulates the gain-adjusted RF signal with the second dither signal to output the amplitude-modulated RF signal to the RF side MZM 32A2 of the Yq channel. Then, the RF side MZM 32A2 of the Yq channel phase-modulates on the optical signal according to the RF signal of the Yq channel. The detection unit 12 detects the first fluctuation level and the second fluctuation level of the Yq channel from the optical output level that is the optical signal from the output stage of the optical modulation unit 2A.

The DRV control unit 55B executes the FB control of the gain of the driver amplifier 21D of the Yq channel so that the first fluctuation level of the Yq channel and the second fluctuation level of the Yq channel are canceled out (Step S45C). The DRV control unit 55B determines whether the FB control of the gain of the driver amplifier 21D of the Yq channel is completed (Step S46C).

In a case where the FB control of the gain of the driver amplifier 21D of the Yq channel is completed (Step S46C: Yes), the first addition processor 55A1 turns off the first dither signal to be added to the bias signal for the DC side slave MZM 32B2 of the Yq channel (Step S47C). Further, the second addition processor 55B1 turns off the second dither signal for the driver amplifier 21D of the Yq channel (Step S48C). Then, the DRV control unit 55B stops the DRV control on the driver amplifier 21D of the Yq channel (Step S49C), and ends the process operation illustrated in FIG. 10B. Further, in a case where the FB control of the gain adjustment of the driver amplifier 21D of the Yq channel is not completed (Step S46C: No), the DRV control unit 55B returns the process to the process of Step S45C for executing the FB control of adjusting the gain of the driver amplifier 21D of the Yq channel.

In the second DRV control process, after the ABC control process is executed, the gain of the driver amplifier 21 of each channel is adjusted so that the second fluctuation level and the first fluctuation level are canceled out for each channel. As a result, since the output amplitude of the driver amplifier 21 can be controlled to be constant, the optical output of the optical modulation unit 2A can be stabilized.

The optical transmitter 2 of the second embodiment adjusts the gain of the driver amplifier 21 of each channel so that the first dither signal and the second dither signal have an opposite phase correlation, and the second fluctuation level and the first fluctuation level are canceled out for each channel. As a result, since the output amplitude of the driver amplifier 21 is constant, the optical output of the optical modulation unit 2A can be stabilized.

Note that, in the optical transmitter 2 of the second embodiment, the first fluctuation level of f of the ABC convergence point has been exemplified as the reference of the feedback information, but the present invention is not limited thereto, and an embodiment thereof will be described below as the third embodiment.

### (c) Third Embodiment

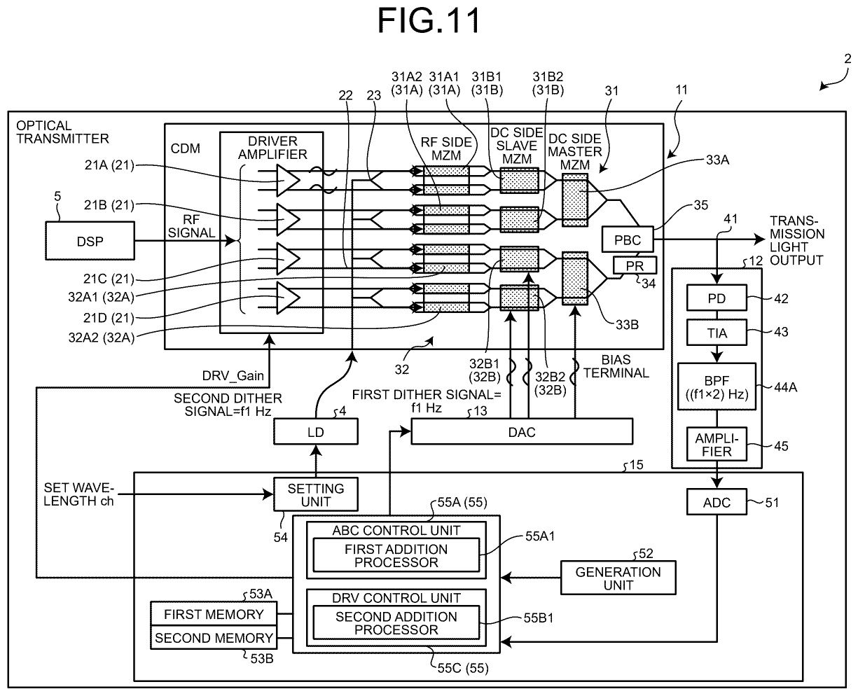

FIG. 11 is an explanatory diagram illustrating an example of the optical transmitter 2 of the third embodiment. Note that the same components as those of the optical transmitter 2 of the second embodiment are denoted by the same reference numerals, and the description of the overlapping components and operations will be omitted. The optical transmitter 2 of the third embodiment is different from the optical transmitter 2 of the second embodiment in that the first fluctuation level of 2f of the ABC convergence point is used as a reference of the feedback information. The first fluctuation level of 2f is a fluctuation level that is twice the first fluctuation level of f of the second embodiment.

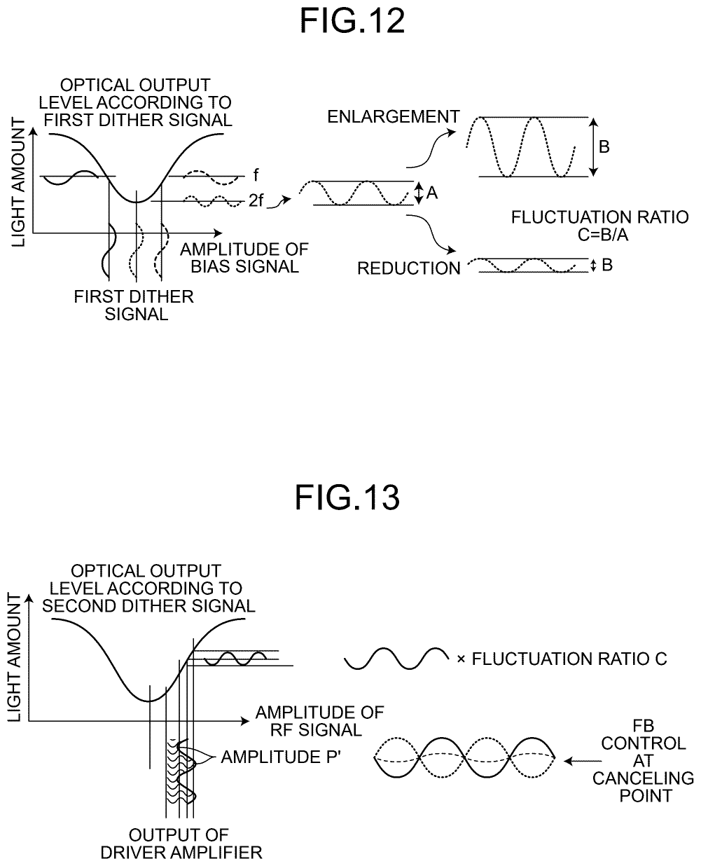

FIG. 12 is an explanatory diagram illustrating an example of an optical output level and a first fluctuation level according to a first dither signal of the optical modulation unit 2A of the third embodiment. In FIG. 12, the optical output level according to the first dither signal is the optical output of the optical modulation unit 2A with the vertical axis representing the light amount and the horizontal axis representing the amplitude of the bias signal. A DRV control unit 55C can acquire the first fluctuation level of 2f that is the fluctuation level of the first dither signal from the optical output level through the detection unit 12. There is a possibility that the first fluctuation level of 2f may change due to, for example, aging or temperature variation. Therefore, the initial first fluctuation level of 2f is stored in a first memory 53A in advance. Note that the amplitude value of the first fluctuation level of 2f is an initial amplitude value A.

The control unit 55 includes a DRV control unit 55C including the second addition processor 55B1 instead of the DRV control unit 55B. When starting the second DRV control process, the DRV control unit 55C measures the current first fluctuation level of 2f, and stores the current first fluctuation level of 2f in a second memory 53B. At this time, the amplitude value of the first fluctuation level of 2f at the current time is a current amplitude value B.

The DRV control unit 55C periodically measures and stores the current amplitude value B of the current first fluctuation level, and calculates the fluctuation ratio C of the first fluctuation level from the initial value based on (current amplitude value B÷initial amplitude value A).

FIG. 13 is an explanatory diagram illustrating an example of an optical output level and a second fluctuation level according to a second dither signal of the optical modulation unit 2A of the third embodiment. In FIG. 13, the optical output level according to the second dither signal is the optical output of the optical modulation unit 2A with the vertical axis representing the light amount and the horizontal axis representing the amplitude of the RF signal. The DRV control unit 55B can acquire the second fluctuation level that is the fluctuation level of the second dither signal from the optical output level through the detection unit 12. The DRV control unit 55C detects the amplitude P of the second fluctuation level of the second dither signal for each channel, and corrects the second fluctuation level of 2f based on (the amplitude P of the second fluctuation level×the fluctuation ratio C). As a result, the secular change in the first fluctuation level of 2f serving as the feedback reference can be reflected on the second fluctuation level to absorb the error of the secular change.

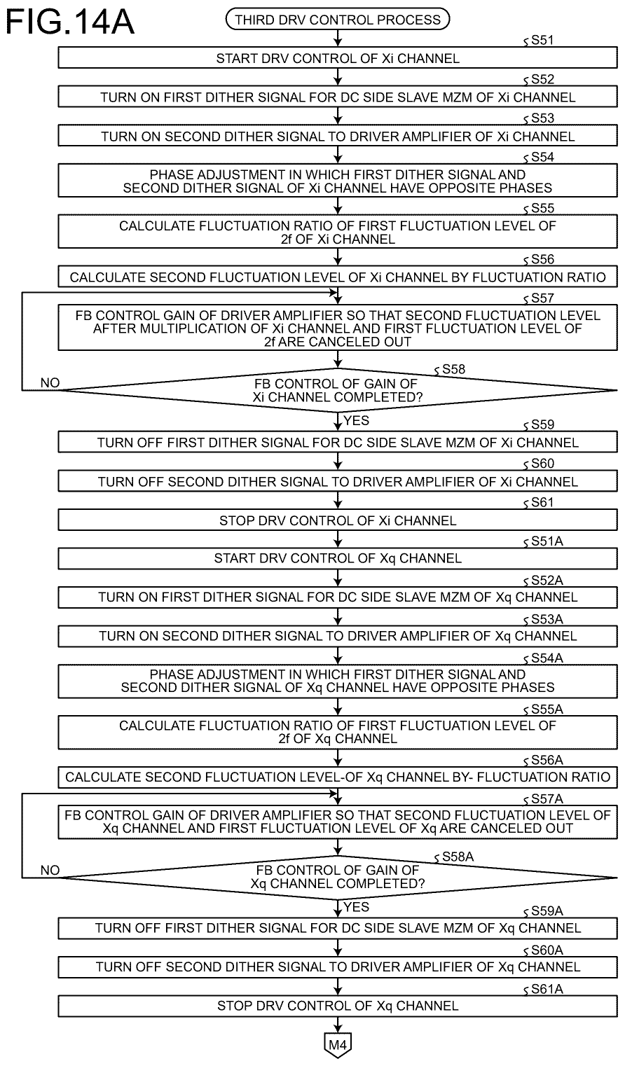

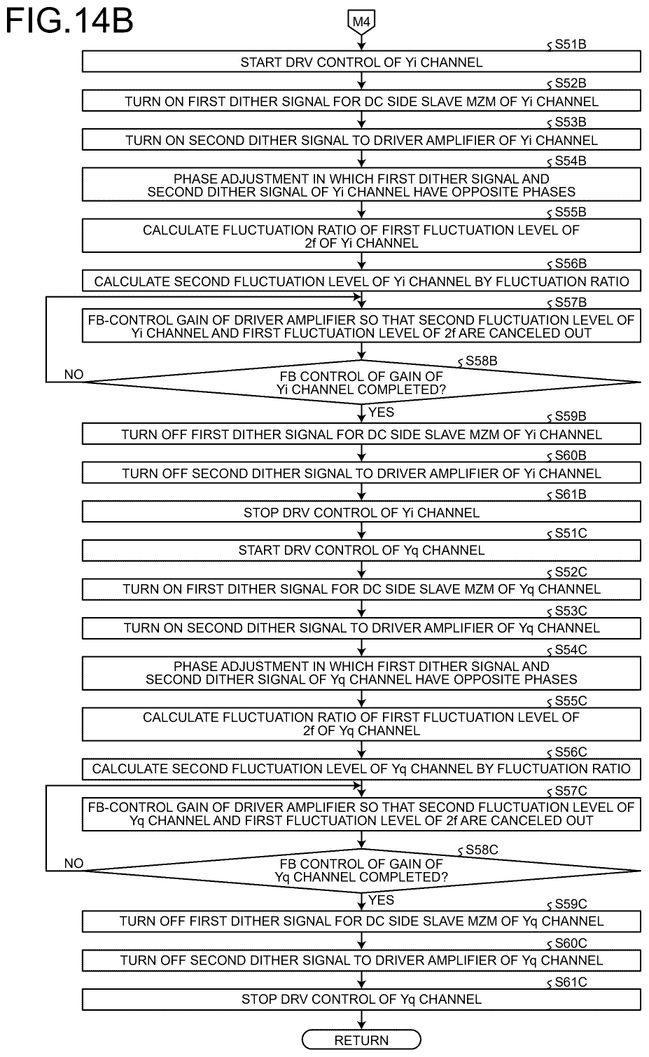

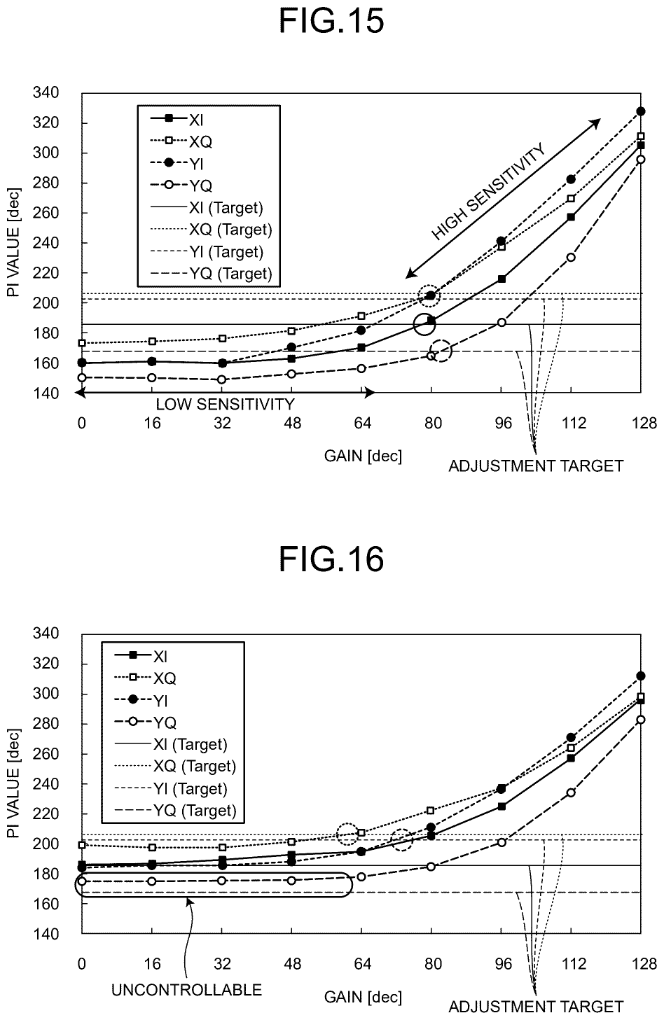

FIGS. 14A and 14B are flowcharts illustrating an example of the processing operation of the DRV control unit 55C related to the third DRV control process of the optical modulation unit 2A. In FIG. 14A, the DRV control unit 55C starts the DRV control on the driver amplifier 21A of the Xi channel (Step S51). The first addition processor 55A1 turns on the first dither signal to be added to the bias signal for the DC side slave MZM 31B1 of the Xi channel (Step S52). The second addition processor 55B1 turns on the second dither signal for the driver amplifier 21A of the Xi channel (Step S53).

The control unit 55 performs phase adjustment so that the first dither signal to be added to the bias signal for the DC side slave MZM 31B1 of the Xi channel and the second dither signal to be added to the RF signal for the driver amplifier 21A of the Xi channel have opposite phases (Step S54). As a result, the driver amplifier 21A amplitude-modulates the gain-adjusted RF signal with the second dither signal to output the amplitude-modulated RF signal to the RF side MZM 31A1 of the Xi channel. Then, the RF side MZM 31A1 of the Xi channel phase-modulates on the optical signal according to the RF signal of the Xi channel. The detection unit 12 detects the first fluctuation level and the second fluctuation level of 2f of the Xi channel from the optical output level that is an optical signal from the output stage of the optical modulation unit 2A.

The DRV control unit 55C calculates the fluctuation ratio of the first fluctuation level of the Xi channel based on (A1/A2) using a first fluctuation level A1 of 2f of the Xi channel and a first fluctuation level A2 of 2f of the Xi channel having the initial value stored in advance (Step S55).

The DRV control unit 55C calculates the second fluctuation level of the Xi channel reflecting the fluctuation ratio based on (B1×fluctuation ratio) using a second fluctuation level B1 of the Xi channel and the fluctuation ratio of the first fluctuation level of the Xi channel (Step S56).

The DRV control unit 55C performs the FB control of the gain of the driver amplifier 21A of the Xi channel so that the current first fluctuation level of 2f of the Xi channel and the second fluctuation level reflecting the fluctuation ratio of the Xi channel are canceled out (Step S57). The DRV control unit 55C determines whether the FB control of the gain of the driver amplifier 21A of the Xi channel is completed (Step S58).

In a case where the FB control of the gain of the driver amplifier 21A of the Xi channel is completed (Step S58: Yes), the first addition processor 55A1 turns off the first dither signal to be added to the bias signal for the DC side slave MZM 31B1 of the Xi channel (Step S59). Furthermore, the second addition processor 55B1 turns off the second dither signal to be added to the RF signal for the driver amplifier 21A of the Xi channel (Step S60). Then, the DRV control unit 55C stops the DRV control on the driver amplifier 21A of the Xi channel (Step S61). In a case where the FB control of gain adjustment of the driver amplifier 21A of the Xi channel is not completed (Step S58: No), the DRV control unit 55C returns the process to the process of Step S57 for executing the FB control of adjusting the gain of the driver amplifier 21A of the Xi channel.

After stopping the DRV control on the driver amplifier 21A of the Xi channel, the DRV control unit 55C starts the DRV control on the driver amplifier 21B of the Xq channel (Step S51A). The first addition processor 55A1 turns on the first dither signal to be added to the bias signal for the DC side slave MZM 31B2 of the Xq channel (Step S52A). The second addition processor 55B1 turns on the second dither signal to be added to the RF signal for the driver amplifier 21B of the Xq channel (Step S53A).

The control unit 55 performs phase adjustment so that the first dither signal for the DC side slave MZM 31B2 of the Xq channel and the second dither signal for the driver amplifier 21B of the Xq channel have opposite phases (Step S54A). As a result, the driver amplifier 21B amplitude-modulates the gain-adjusted RF signal with the second dither signal to output the amplitude-modulated RF signal to the RF side MZM 31A2 of the Xq channel. Then, the RF side MZM 31A2 of the Xq channel phase-modulates on the optical signal according to the RF signal of the Xq channel. The detection unit 12 detects the first fluctuation level and the second fluctuation level of 2f of the Xq channel from the optical output level that is the optical signal from the output stage of the optical modulation unit 2A.

The DRV control unit 55C calculates the fluctuation ratio of the first fluctuation level of 2f of the Xq channel based on (A1/A2) using the first fluctuation level A1 of 2f of the Xq channel and the first fluctuation level A2 of 2f of the Xq channel having the initial value stored in advance (Step S55A).

The DRV control unit 55C calculates the second fluctuation level of the Xq channel reflecting the fluctuation ratio based on (B1×fluctuation ratio) using the second fluctuation level B1 of the Xq channel and the fluctuation ratio of the first fluctuation level of the Xq channel (Step S56A).

The DRV control unit 55C performs the FB control of the gain of the driver amplifier 21B of the Xq channel so that the current first fluctuation level of the Xq channel and the second fluctuation level reflecting the fluctuation ratio of the Xq channel are canceled (Step S57A). The DRV control unit 55C determines whether the FB control of the gain of the driver amplifier 21B of the Xq channel is completed (Step S58A).

In a case where the FB control of the gain of the driver amplifier 21B of the Xq channel is completed (Step S58A: Yes), the first addition processor 55A1 turns off the first dither signal to be added to the bias signal for the DC side slave MZM 31B2 of the Xq channel (Step S59A). Further, the second addition processor 55B1 turns off the second dither signal to be added to the RF signal for the driver amplifier 21B of the Xq channel (Step S60A). Then, the DRV control unit 55C stops the DRV control on the driver amplifier 21B of the Xq channel (Step S61A), and advances the process to the process of M4 illustrated in FIG. 14B. Further, in a case where the FB control of the gain adjustment of the driver amplifier 21B of the Yi channel is not completed (Step S58A: No), the DRV control unit 55C returns the process to the process of Step S57A of executing the FB control of adjusting the gain of the driver amplifier 21B of the Yi channel.

In M4 of FIG. 14B, after stopping the DRV control on the driver amplifier 21B of the Xq channel, the DRV control unit 55C starts the DRV control on the driver amplifier 21C of the Yi channel (Step S51B). The first addition processor 55A1 turns on the first dither signal to be added to the bias signal for the DC side slave MZM 32B1 of the Yi channel (Step S52B). The second addition processor 55B1 turns on the second dither signal to be added to the RF signal for the driver amplifier 21C of the Yi channel (Step S53B).

The control unit 55 performs phase adjustment so that the first dither signal to be added to the bias signal for the DC side slave MZM 32B1 of the Yi channel and the second dither signal to be added to the RF signal for the driver amplifier 21C of the Yi channel have opposite phases (Step S54B). As a result, the driver amplifier 21C amplitude-modulates the gain-adjusted RF signal with the second dither signal to output the amplitude-modulated RF signal to the RF side MZM 32A1 of the Yi channel. Then, the RF side MZM 32A1 of the Yi channel phase-modulates the optical signal according to the RF signal of the Yi channel. The detection unit 12 detects the first fluctuation level and the second fluctuation level of 2f of the Yi channel from the optical output level that is the optical signal from the output stage of the optical modulation unit 2A.

The DRV control unit 55C calculates the fluctuation ratio of the first fluctuation level of 2f of the Yi channel based on (A1/A2) using the first fluctuation level A1 of 2f of the Yi channel and the first fluctuation level A2 of 2f of the Yi channel having the initial value stored in advance (Step S55B).

The DRV control unit 55C calculates the second fluctuation level of the Yi channel reflecting the fluctuation ratio based on (B1×fluctuation ratio) using the second fluctuation level B1 of the Yi channel and the fluctuation ratio of the first fluctuation level of the Yi channel (Step S56B).

The DRV control unit 55C performs the FB control of the gain of the driver amplifier 21C of the Yi channel so that the current first fluctuation level of 2f of the Yi channel and the second fluctuation level reflecting the fluctuation ratio of the Yi channel are canceled (Step S57B). The DRV control unit 55C determines whether the FB control of the gain of the driver amplifier 21C of the Yi channel is completed (Step S58B).

In a case where the FB control of the gain of the driver amplifier 21C of the Yi channel is completed (Step S58B: Yes), the first addition processor 55A1 turns off the first dither signal to be added to the bias signal for the DC side slave MZM 32B1 of the Yi channel (Step S59B). Furthermore, the second addition processor 55B1 turns off the second dither signal for the driver amplifier 21C of the Yi channel (Step S60B). Then, the DRV control unit 55C stops the DRV control on the driver amplifier 21C of the Yi channel (Step S61B). Further, in a case where the FB control of the gain adjustment of the driver amplifier 21C of the Yi channel is not completed (Step S58B: No), the DRV control unit 55C returns the process to the process of Step S57B of executing the FB control of adjusting the gain of the driver amplifier 21C of the Yi channel.

After stopping the DRV control on the driver amplifier 21C of the Yi channel, the DRV control unit 55C starts the DRV control on the driver amplifier 21D of the Yq channel (Step S51C). The first addition processor 55A1 turns on the first dither signal to be added to the bias signal for the DC side slave MZM 32B2 of the Yq channel (Step S52C). The second addition processor 55B1 turns on the second dither signal to be added to the RF signal for the driver amplifier 21D of the Yq channel (Step S53C).

The control unit 55 performs phase adjustment so that the first dither signal to be added to the bias signal for the DC side slave MZM 32B2 of the Yq channel and the second dither signal to be added to the RF signal for the driver amplifier 21D of the Yq channel have opposite phases (Step S54C). As a result, the driver amplifier 21D amplitude-modulates the gain-adjusted RF signal with the second dither signal to output the amplitude-modulated RF signal to the RF side MZM 32A2 of the Yq channel. Then, the RF side MZM 32A2 of the Yq channel phase-modulates on the optical signal according to the RF signal of the Yq channel. The detection unit 12 detects the first fluctuation level and the second fluctuation level of 2f of the Yq channel from the optical output level that is the optical signal from the output stage of the optical modulation unit 2A.

The DRV control unit 55C calculates the fluctuation ratio of the first fluctuation level of the Yq channel based on (A1/A2) using the first fluctuation level A1 of 2f of the Yq channel and the first fluctuation level A2 of 2f of the Yq channel having the initial value stored in advance (Step S55C).

The DRV control unit 55C calculates the second fluctuation level of the Yq channel reflecting the fluctuation ratio based on (B1×fluctuation ratio) using the second fluctuation level B1 of the Yq channel and the fluctuation ratio of the first fluctuation level of 2f of the Yq channel (Step S56C).

The DRV control unit 55C performs the FB control of the gain of the driver amplifier 21D of the Yq channel so that the current first fluctuation level of 2f of the Yq channel and the second fluctuation level reflecting the fluctuation ratio of the Yq channel are canceled (Step S57C). The DRV control unit 55C determines whether the FB control of the gain of the driver amplifier 21D of the Yq channel is completed (Step S58C).

In a case where the FB control of the gain of the driver amplifier 21D of the Yq channel is completed (Step S58C: Yes), the first addition processor 55A1 turns off the first dither signal to be added to the bias signal for the DC side slave MZM 32B2 of the Yq channel (Step S59C). Furthermore, the second addition processor 55B1 turns off the second dither signal to be added to the RF signal for the driver amplifier 21D of the Yq channel (Step S60C). Then, the DRV control unit 55C stops the DRV control on the driver amplifier 21D of the Yq channel (Step S61C), and ends the process operation illustrated in FIG. 14B. Further, in a case where the FB control of the gain adjustment of the driver amplifier 21D of the Yq channel is not completed (Step S58C: No), the DRV control unit 55C returns the process to the process of Step S57C for executing the FB control of adjusting the gain of the driver amplifier 21D of the Yq channel.

In the third DRV control process, after the ABC control process is executed, the gain of the driver amplifier 21 of each channel is adjusted so that the second fluctuation level reflecting the fluctuation ratio of the first fluctuation level and the current first fluctuation level of 2f are canceled out for each channel. As a result, since the output amplitude of the driver amplifier 21 can be controlled to be constant, the optical output of the optical modulation unit 2A can be stabilized. The error of the secular change can be absorbed by reflecting the secular change in the first fluctuation level of 2f serving as the feedback reference on the second fluctuation level.

The optical transmitter 2 of the third embodiment calculates a fluctuation ratio between the detected first fluctuation level and a preset initial first fluctuation level. Then, the optical transmitter 2 adjusts the detected second fluctuation level according to the calculated fluctuation ratio, and controls the gain of the driver amplifier 21 so that the adjusted second fluctuation level and the detected first fluctuation level are canceled out. As a result, since the output amplitude of the driver amplifier 21 can be controlled to be constant, the optical output of the optical modulation unit 2A can be stabilized. The error of the secular change can be absorbed by reflecting the secular change in the first fluctuation level of 2f serving as the feedback reference on the second fluctuation level.

Note that, for convenience of description, the case where the optical transceiver 1 incorporates the optical transmitter 2 and the optical receiver 3 has been exemplified, but the optical transceiver 1 may incorporate any one of the optical transmitter 2 and the optical receiver 3. For example, the optical transceiver 1 incorporating the optical transmitter 2 may be used, and the optical transceiver 1 can be appropriately changed.

In addition, each component of each unit illustrated in the drawings is not necessarily physically configured as illustrated in the drawings. That is, a specific form of distribution and integration of each unit is not limited to the illustrated form, and all or part thereof can be functionally or physically distributed and integrated in an any unit according to various loads, usage conditions, and the like.

Furthermore, all or any part of various processing functions performed in each device may be executed on a central processing unit (CPU) (or a micro computer such as a micro processing unit (MPU) or a micro controller unit (MCU)). In addition, it goes without saying that all or any part of the various processing functions may be executed on a program to be analyzed and executed by a CPU (or a micro computer such as an MPU or an MCU.) or on hardware by wired logic.

According to an aspect, light output can be stabilized.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmitter comprising:
a driver amplifier that amplifies a high-frequency signal;
a addition processor that adds a dither signal to the high-frequency signal amplified by the driver amplifier;
an optical modulator that modulates an optical signal according to the high-frequency signal to which the dither signal is added;
a detector that detects a fluctuation level of the dither signal from the modulated optical signal; and
a controller that controls a gain of the driver amplifier that amplifies the high-frequency signal so that an output amplitude of the driver amplifier is constant based on the detected fluctuation level of the dither signal.

2. The optical transmitter according to claim 1, wherein the controller controls a gain of the driver amplifier so that a fluctuation level, of the dither signal, detected by the detector matches a predetermined fluctuation level set in advance.

3. The optical transmitter according to claim 1, wherein
the optical modulator includes:
a phase modulator that phase-modulates an optical signal according to the high-frequency signal, and
a phase adjustor that phase-adjusts the optical signal phase-modulated by the phase modulator according to a bias signal,
the addition processor includes
a second addition processor that adds a second dither signal that is the dither signal to the high-frequency signal amplified by the driver amplifier, and
a first addition processor that adds a first dither signal having a frequency same as a frequency of the second dither signal to the bias signal,
the detector detects fluctuation levels of the first dither signal and the second dither signal from the optical signal modulated by the optical modulator, and
the controller includes:
a first controller unit that controls the bias signal based on a fluctuation level of the first dither signal, and
a second controller that controls a gain of the driver amplifier based on a fluctuation level of the second dither signal after the first controller controls the bias signal.

4. The optical transmitter according to claim 3, wherein
the first dither signal and the second dither signal have an opposite phase correlation, and
the controller controls a gain of the driver amplifier so that the first dither signal and the second dither signal are canceled out.

5. The optical transmitter according to claim 4, wherein the controller adjusts a fluctuation level, of the second dither signal, detected by the detector according to a fluctuation ratio between a fluctuation level, of the first dither signal, detected by the detector and an initial fluctuation level set in advance, and controls a gain of the driver amplifier so that the adjusted fluctuation level of the second dither signal and the fluctuation level, of the first dither signal, detected by the detector are canceled out.

6. An optical transceiver comprising:
an optical transmitter that outputs transmission light using an electrical signal and an optical signal according to transmission data; an optical receiver that receives reception light using the optical signal and obtains an electrical signal according to reception data from the received reception light; and a processor that executes a signal process on the electrical signal, wherein
the optical transmitter includes
a driver amplifier that amplifies a high-frequency signal,
a addition processor that adds a dither signal to the high-frequency signal amplified by the driver amplifier,
an optical modulator that modulates an optical signal according to the high-frequency signal to which the dither signal is added,
a detector that detects a fluctuation level of the dither signal from the modulated optical signal, and
a controller that controls a gain of the driver amplifier that amplifies the high-frequency signal so that an output amplitude of the driver amplifier is constant based on the detected fluctuation level of the dither signal.
